(19) United States
(12) Patent Application Publication
(10) Pub. No.: US 2026/0012309 A1
(43) Pub. Date: Jan. 8, 2026

(54) Pilot Tone Design For Distributed-Tone Resource Units In 6GHz Low-Power Indoor Systems

(71) Applicant: MediaTek Singapore Pte. Ltd., Singapore (SG)

(72) Inventors: Shengquan Hu, San Jose, CA (US); Jianhan Liu, San Jose, CA (US); Thomas Edward Pare, JR., San Jose, CA (US)

(73) Assignee: MediaTek Singapore Pte. Ltd., Singapore (SG)

(21) Appl. No.: 19/336,541

(22) Filed: Sep. 23, 2025

Related U.S. Application Data
(63) Continuation of application No. 17/670,491, filed on Feb. 13, 2022, now Pat. No. 12,452,010.
(60) Provisional application No. 63/150,154, filed on Feb. 17, 2021.
(60) Provisional application No. 63/231,809, filed on Aug. 11, 2021.
(60) Provisional application No. 63/232,699, filed on Aug. 13, 2021.

(51) Int. Cl. H04L 5/00; H04L 25/02; H04L 27/26

(52) U.S. Cl. CPC H04L 5/0048; H04L 25/0224; H04L 27/2613

(57) ABSTRACT

Various schemes pertaining to pilot tone design for distributed-tone resource units (dRUs) in 6 GHz low-power indoor (LPI) systems are described. A communication entity generates a plurality of pilot tones of a dRU based on a hierarchical structure of pilot tones that is used for a regular RU (rRU). The communication entity then communicates with another communication entity using the dRU.

### CROSS REFERENCE TO RELATED PATENT APPLICATION

The present disclosure is part of a Continuation of U.S. patent application Ser. No. 17/670,491, filed 13 Feb. 2022 and claiming the priority benefit of U.S. Provisional Patent Application Nos. 63/150,154, 63/231,809 and 63/232,699, filed 17 Feb. 2021, 11 Aug. 2021 and 13 Aug. 2021, respectively. Contents of the aforementioned applications are herein incorporated by reference in their entirety.

### TECHNICAL FIELD

The present disclosure is generally related to wireless communications and, more particularly, to pilot tone design for distributed-tone resource units (dRUs) in 6 GHz low-power indoor (LPI) systems.

### BACKGROUND

Unless otherwise indicated herein, approaches described in this section are not prior art to the claims listed below and are not admitted as prior art by inclusion in this section.

Under current regulations by the Federal Communications Commission (FCC) regarding wireless communications in the 2.4-GHz and 5-GHz bands, the equivalent isotropically radiated power (EIRP) of a power spectral density (PSD) limit is capped at 20 dBm for 2-MHz transmission and the transmission (Tx) power limit is capped at 30 dBm. With a reasonable Tx power assumption, the FCC requirement would not limit Tx power for narrow-bandwidth transmissions. On the other hand, the FCC requirement regarding 6-GHz LPI applications is far more stringent than PSD requirement for the 2.4-GHz and 5-GHz bands. For instance, the EIRP limit is at 5 dBm/MHz for an access point (AP) in 6-GHz LPI versus an EIRP limit of 17 dBm/MHz for APs in the 5-GHz band. Similarly, the EIRP limit is at −1 dBm/MHz for an non-AP in 6-GHz LPI versus an EIRP limit of 11 dBm/MHz for non-APs in the 5-GHz band.

Distributed-tone resource units (RUs) and multi-RU (MRU) have been proposed to spread subcarriers over a wider bandwidth to boost transmit power and extend coverage range, and several pilot tone design methods have been proposed to assign pilot tones in a dRU. However, the pilot tones from all triggered uplink (UL) trigger-based (TB) orthogonal frequency-division multiple-access (OFDMA) dRUs may be squeezed in several clusters at an AP receiver, and the “clustered” pilots from all stations (STAs) received by AP may potentially have issues for narrowband interference (NBI). Therefore, there is a need for a solution to optimize pilot tone design for distributed-tone RUs in 6 GHz LPI systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to pilot tone design for distributed-tone RUs (dRUs) in 6 GHz LPI systems. It is believed that the pilot tone design under various proposed schemes may achieve some benefits. Specifically, it is believed that the proposed pilot tone design may spread pilot tones over an entire bandwidth or frequency subblock with no resultant cluster and with no pilot tones being adjacent with each other. Additionally, overall pilot tones may be evenly or near-evenly distributed under the proposed pilot tone design. Moreover, under the proposed pilot tone design, the hierarchical structure for regular RU pilot tones may be maintained for pilot tones of dRUs. For instance, pilot tones of a 52-tone dRU may include pilot tones from corresponding two 26-tone dRUs, pilot tones of a 106-tone dRU may include pilot tones from corresponding two 52-tone dRUs, pilot tones of a 242-tone dRU may include pilot tones from corresponding two 106-tone dRUs, and pilot tones of a 484-tone dRU may include pilot tones from corresponding two 242-tone dRUs.

In one aspect, a method may involve generating a plurality of pilot tones of a dRU (e.g., by distributing subcarriers of a RU) based on a hierarchical structure of pilot tones that is used for a regular RU (rRU). The method may also involve communicating using the dRU.

In another aspect, an apparatus may include a transceiver configured to transmit and receive wirelessly. The apparatus may also include a processor coupled to the transceiver. The processor may generate a plurality of pilot tones of a dRU (e.g., by distributing subcarriers of a RU) based on a hierarchical structure of pilot tones that is used for a rRU. The processor may also communicate, via the transceiver, using the dRU.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example design in accordance with an implementation of the present disclosure.

FIG. 4 is a diagram of an example scenario in accordance with an implementation of the present disclosure.

FIG. 5 is a diagram of an example design in accordance with an implementation of the present disclosure.

FIG. 6 is a diagram of an example scenario in accordance with an implementation of the present disclosure.

FIG. 7 is a diagram of an example design in accordance with an implementation of the present disclosure.

FIG. 8 is a diagram of an example design in accordance with an implementation of the present disclosure.

FIG. 9 is a diagram of an example design in accordance with an implementation of the present disclosure.

FIG. 10 is a diagram of an example design in accordance with an implementation of the present disclosure.

FIG. 11 is a diagram of an example design in accordance with an implementation of the present disclosure.

FIG. 12 is a diagram of an example design in accordance with an implementation of the present disclosure.

FIG. 13 is a diagram of an example design in accordance with an implementation of the present disclosure.

FIG. 14 is a diagram of an example design in accordance with an implementation of the present disclosure.

FIG. 15 is a diagram of an example design in accordance with an implementation of the present disclosure.

FIG. 16 is a diagram of an example scenario in accordance with an implementation of the present disclosure.

FIG. 17 is a diagram of an example scenario in accordance with an implementation of the present disclosure.

FIG. 18 is a diagram of an example scenario in accordance with an implementation of the present disclosure.

FIG. 19 is a diagram of an example scenario in accordance with an implementation of the present disclosure.

FIG. 20 is a diagram of an example scenario in accordance with an implementation of the present disclosure.

FIG. 21 is a diagram of an example scenario in accordance with an implementation of the present disclosure.

FIG. 22 is a diagram of an example scenario in accordance with an implementation of the present disclosure.

FIG. 23 is a diagram of an example scenario in accordance with an implementation of the present disclosure.

FIG. 24 is a diagram of an example scenario in accordance with an implementation of the present disclosure.

FIG. 25 is a diagram of an example design in accordance with an implementation of the present disclosure.

FIG. 26 is a diagram of an example design in accordance with an implementation of the present disclosure.

FIG. 27 is a diagram of an example design in accordance with an implementation of the present disclosure.

FIG. 28 is a diagram of an example design in accordance with an implementation of the present disclosure.

FIG. 29 is a diagram of an example design in accordance with an implementation of the present disclosure.

FIG. 30 is a diagram of an example design in accordance with an implementation of the present disclosure.

FIG. 31 is a diagram of an example scenario in accordance with an implementation of the present disclosure.

FIG. 32 is a diagram of an example design in accordance with an implementation of the present disclosure.

FIG. 33 is a diagram of an example design in accordance with an implementation of the present disclosure.

FIG. 34 is a diagram of an example design in accordance with an implementation of the present disclosure.

FIG. 35 is a diagram of an example design in accordance with an implementation of the present disclosure.

FIG. 36 is a diagram of an example design in accordance with an implementation of the present disclosure.

FIG. 37 is a diagram of an example design in accordance with an implementation of the present disclosure.

FIG. 38 is a diagram of an example design in accordance with an implementation of the present disclosure.

FIG. 39 is a diagram of an example design in accordance with an implementation of the present disclosure.

FIG. 40 is a diagram of an example design in accordance with an implementation of the present disclosure.

FIG. 41 is a diagram of an example design in accordance with an implementation of the present disclosure.

FIG. 42 is a diagram of an example design in accordance with an implementation of the present disclosure.

FIG. 43 is a diagram of an example design in accordance with an implementation of the present disclosure.

FIG. 44 is a block diagram of an example communication system in accordance with an implementation of the present disclosure.

FIG. 45 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to pilot tone design for distributed-tone RUs in 6 GHz LPI systems. According to the present disclosure, a number of possible solutions may be implemented separately or jointly. That is, although these possible solutions may be described below separately, two or more of these possible solutions may be implemented in one combination or another.

It is noteworthy that, in the present disclosure, a 26-tone regular RU may be interchangeably denoted as RU26 (or rRU26), a 52-tone regular RU may be interchangeably denoted as RU52 (or rRU52), a 106-tone regular RU may be interchangeably denoted as RU106 (or rRU106), a 242-tone regular RU may be interchangeably denoted as RU242 (or rRU242), and so on. Moreover, an aggregate (26+52)-tone regular multi-RU (MRU) may be interchangeably denoted as MRU78 (or rMRU78), an aggregate (26+106)-tone regular MRU may be interchangeably denoted as MRU132 (or rMRU132), and so on. Furthermore, in the present disclosure, a 26-tone distributed-tone RU may be interchangeably denoted as dRU26, a 52-tone distributed-tone RU may be interchangeably denoted as dRU52, a 106-tone distributed-tone RU may be interchangeably denoted as dRU106, a 242-tone distributed-tone RU may be interchangeably denoted as dRU242, and so on. Additionally, an aggregate (26+52)-tone distributed-tone MRU may be interchangeably denoted as dMRU78, an aggregate (26+106)-tone distributed-tone MRU may be interchangeably denoted as dMRU132, and so on. Since the above examples are merely illustrative examples and not an exhaustive listing of all possibilities, the same applies to regular RUs, distributed-tone RUs, MRUs, and distributed-tone MRUs of different sizes (or different number of tones). It is also noteworthy that, in the present disclosure, a bandwidth of 20 MHz may be interchangeably denoted as BW20, a bandwidth of 40 MHz may be interchangeably denoted as BW40, a bandwidth of 80 MHz may be interchangeably denoted as BW80, a bandwidth of 160 MHz may be interchangeably denoted as BW160, a bandwidth of 240 MHz may be interchangeably denoted as BW240, and a bandwidth of 320 MHz may be interchangeably denoted as BW320. It is further noteworthy that, in the present disclosure, a 26-tone interleaved-tone or interlaced-tone RU may be interchangeably denoted as iRU26, a 52-tone interleaved-tone or interlaced-tone RU may be interchangeably denoted as iRU52, a 106-tone interleaved-tone or interlaced-tone RU may be interchangeably denoted as iRU106, a 242-tone interleaved-tone or interlaced-tone RU may be interchangeably denoted as iRU242, and a 484-tone interleaved-tone or interlaced-tone RU may be interchangeably denoted as iRU484.

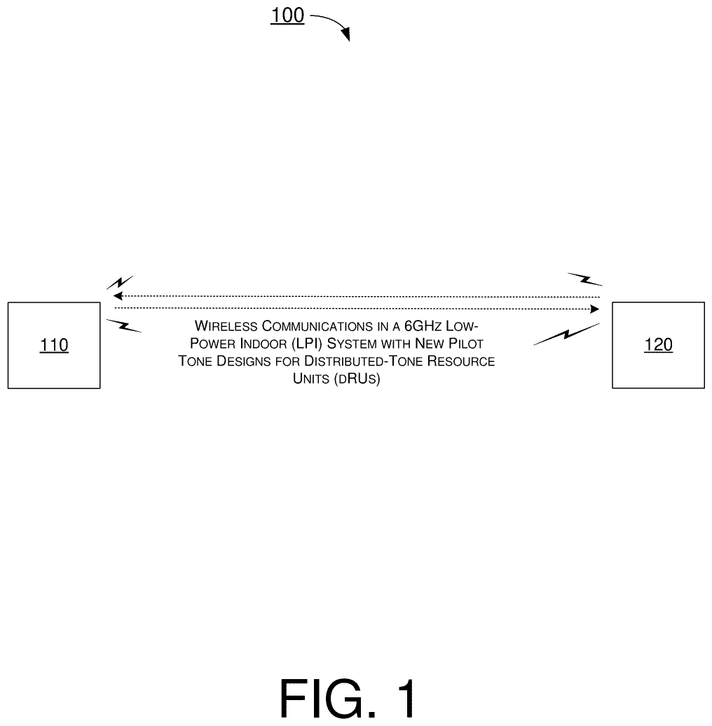

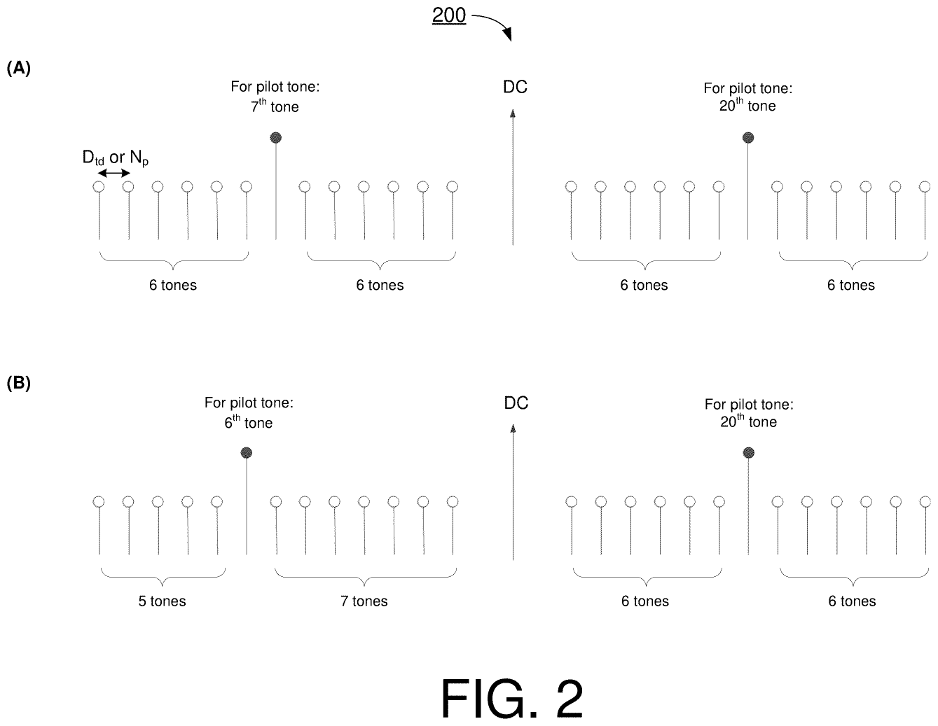

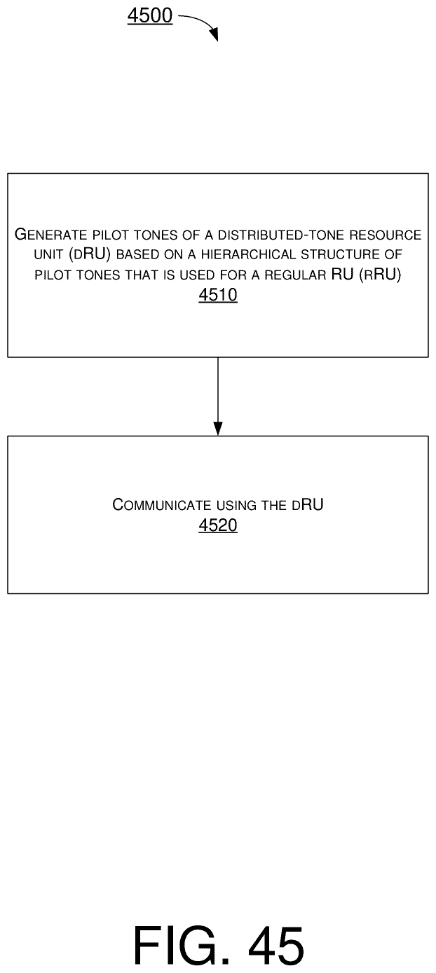

FIG. 1 illustrates an example network environment 100 in which various solutions and schemes in accordance with the present disclosure may be implemented. FIG. 2˜FIG. 45 illustrate examples of implementation of various proposed schemes in network environment 100 in accordance with the present disclosure. The following description of various proposed schemes is provided with reference to FIG. 1˜FIG. 45.

Referring to FIG. 1, network environment 100 may involve a communication entity 110 and a communication entity 120 communicating wirelessly (e.g., in a WLAN in accordance with one or more Institute of Electrical and Electronics Engineers (IEEE) 802.11 standards). For instance, communication entity 110 may be a first STA and communication entity 120 may be a second STA, with each of the first STA and second STA functioning an access point (AP) STA or a non-AP STA. Under various proposed schemes in accordance with the present disclosure, communication entity 110 and communication entity 120 may be configured to communicate wirelessly with pilot tone designs for distributed-tone RUs in 6 GHz LPI systems under various proposed schemes of the present disclosure, as described herein.

In general, the same number of pilot subcarriers in a dRU are kept as that in a rRU with respect to designs of pilot subcarriers for dRUs. For instance, each 26-tone dRU may have two pilot tones, each 52-tone dRU may have four pilot tones, each 106-tone dRU may have four pilot tones, each 242-tone dRU may have eight pilot tones, and each 484-tone dRU may have sixteen pilot tones. Under various proposed schemes in accordance with the present disclosure, there may be at least two options (Option 1 and Option 2) with respect to dRU pilot tone index design. In Option 1, pilot tones of a dRU may be chosen with pre-specified locations to preserve relative pilot positions as in a rRU, and the pilot tones may be either direct-current (DC) tone-symmetric or DC tone-asymmetric. In Option 2, the same hierarchical structure of pilot tones of a rRU may be maintained for a dRU. For instance, the four pilot tones of a 52-tone dRU may include pilot tones from two corresponding 26-tone dRUs (e.g., by taking two pilot tones per 26-tone dRU). Similarly, the four pilot tones of a 106-tone dRU may include pilot tones from two corresponding 52-tone dRUs (e.g., by taking two pilot tones from each 52-tone dRU). Likewise, the eight pilot tones of a 242-tone dRU may include pilot tones from two corresponding 106-tone dRUs (e.g., by taking four pilot tones from each 106-tone dRU). Moreover, the sixteen tones of a 484-tone dRU may include pilot tones from two corresponding 242-tone dRUs (e.g., by taking eight pilot tones from each 242-tone dRU). Under the various proposed schemes, values of regular RU pilot tones under IEEE 802.11be may be reused for dRU pilot tone values. Moreover, pilot mapping rule(s) for regular RU pilot tones under IEEE 802.11be may be reused for dRU pilot tone mapping under the proposed schemes.

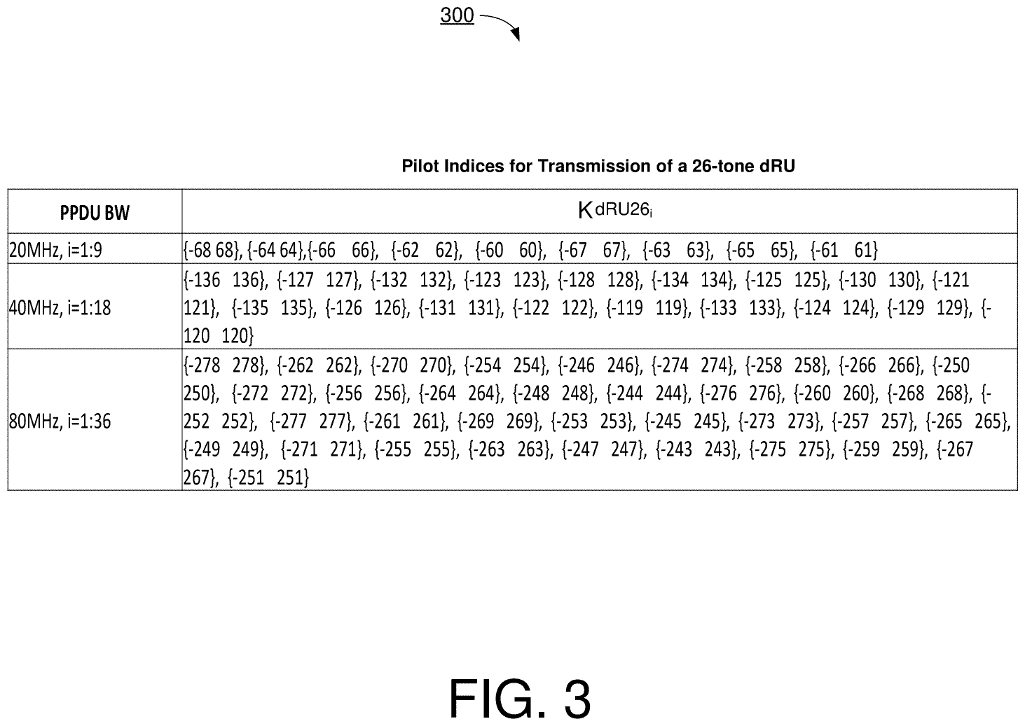

FIG. 2 illustrates an example scenario 200 of a pilot tone design for a 26-tone dRU under a proposed scheme in accordance with the present disclosure. Given that the subcarrier tones of a dRU span across a DC tone, a 26-tone dRU may have thirteen tones in a low part (or left part) and thirteen tones in an upper part (or right part). There are two options (Option-1a and Option-1b) for pilot tone design for a 26-tone dRU in scenario 200, with Option-1a shown in part (A) of FIG. 2 and Option-1b shown in part (B) of FIG. 2. In Option-1a, similar to the pilot tone selection for a regular middle 26-tone RU, the 7^{th} and 20^{th} tones of a dRU26 may be selected from each 26-tone dRU as the pilot tones to preserve the relative pilot positions as in a 26-tone rRU. In Option-1b, relative pilot positions of the pilot tones in the regular 26-tone RU may be preserved by selecting the 6^{th} and 20^{th} tones of a dRU26 from each 26-tone dRU as the pilot tones. FIG. 3 illustrates an example design 300 of pilot tone indices for a 26-tone dRU under Option-1a.

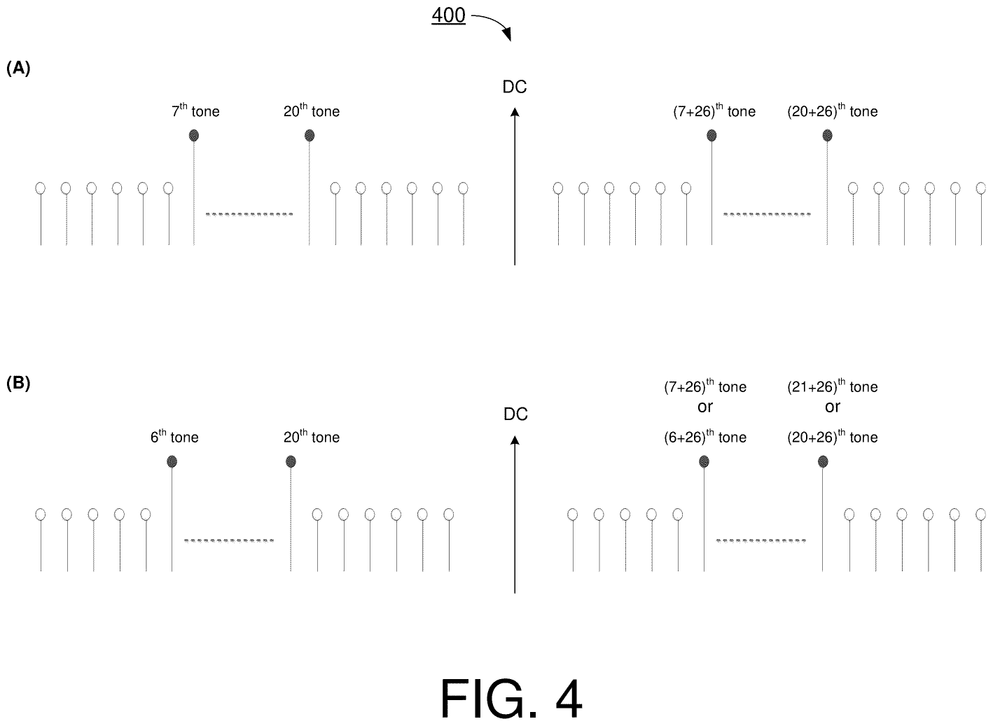

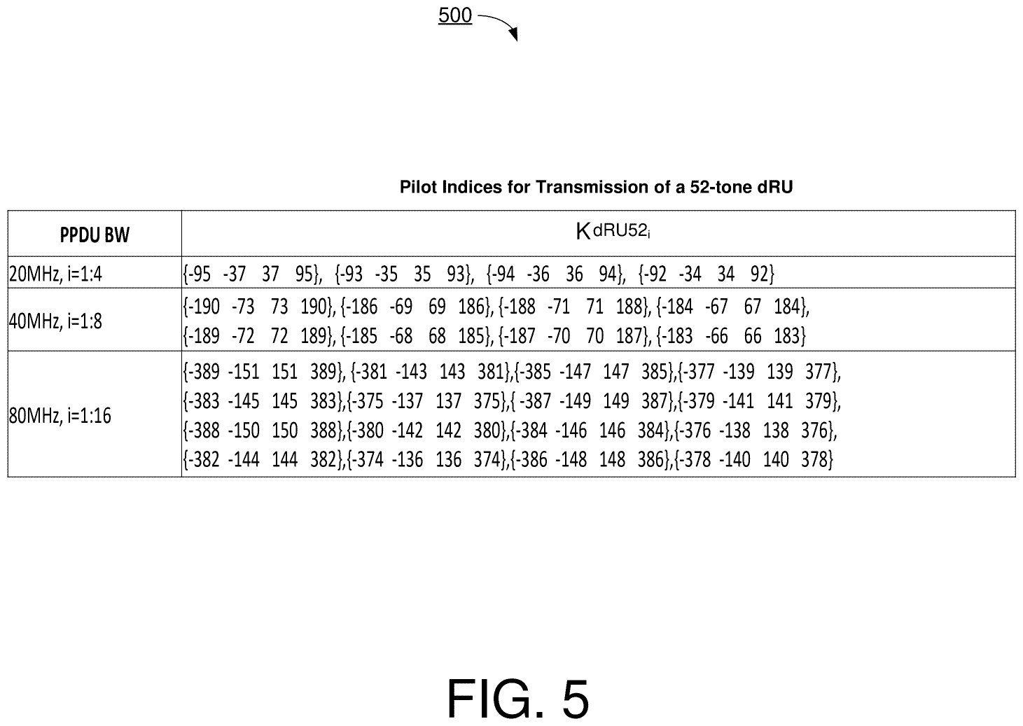

FIG. 4 illustrates an example scenario 400 of a pilot tone design for a 52-tone dRU under a proposed scheme in accordance with the present disclosure. Although each 52-tone dRU may be built from two 26-tone dRUs, unlike a regular 52-tone RU which may be formed by cascading two continuous 26-tone RUs in the frequency domain, the two 26-tone dRU may spread tones over an entire bandwidth in an interleaved fashion. Accordingly, the pilot tones of a 52-tone dRU may not be directly or simply defined from the pilot tones of two 26-tone dRUs in order to achieve a larger distance between pilot tones. Instead, under the proposed scheme, there are two options (Option-1a and Option-1b) for pilot tone design for a 52-tone dRU in scenario 400, with Option-1a shown in part (A) of FIG. 4 and Option-1b shown in part (B) of FIG. 4. In Option-1a, the 7^{th}, 20^{th}, 33^{rd} and 46^{th} tones of a dRU52 may be selected as the pilot tones for each 52-tone dRU. In Option-1b, the 6^{th}, 20^{th}, 32^{nd} (or 33^{rd}) and 46^{th} (or 47^{th}) tones of a dRU52 may be selected as the pilot tones for each 52-tone dRU. FIG. 5 illustrates an example design 500 of pilot tone indices for a 52-tone dRU under Option-1a.

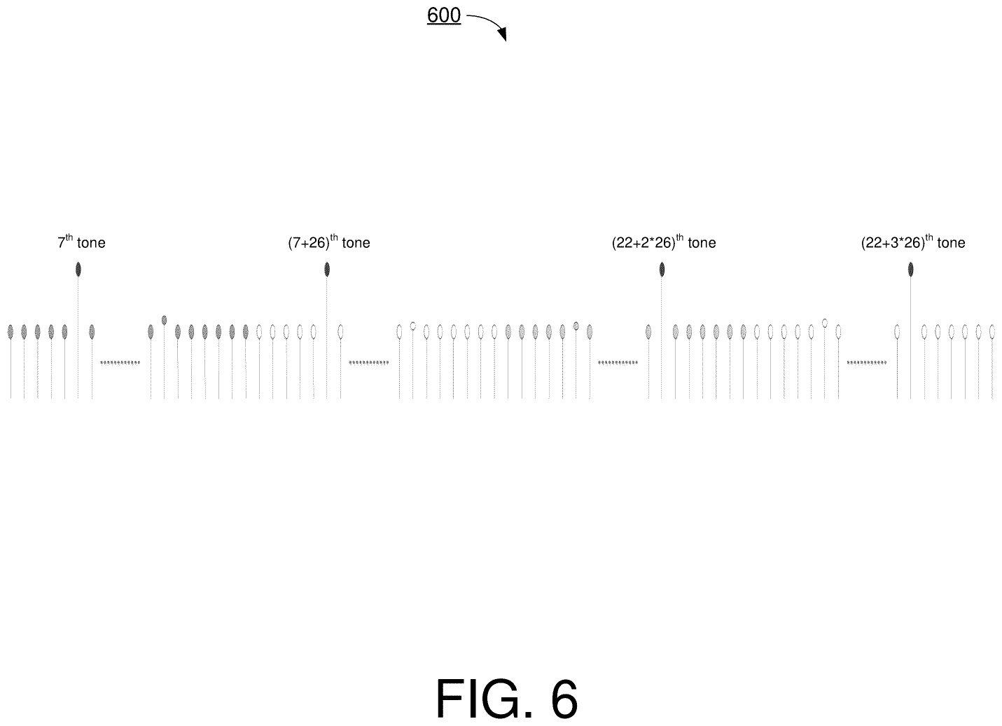

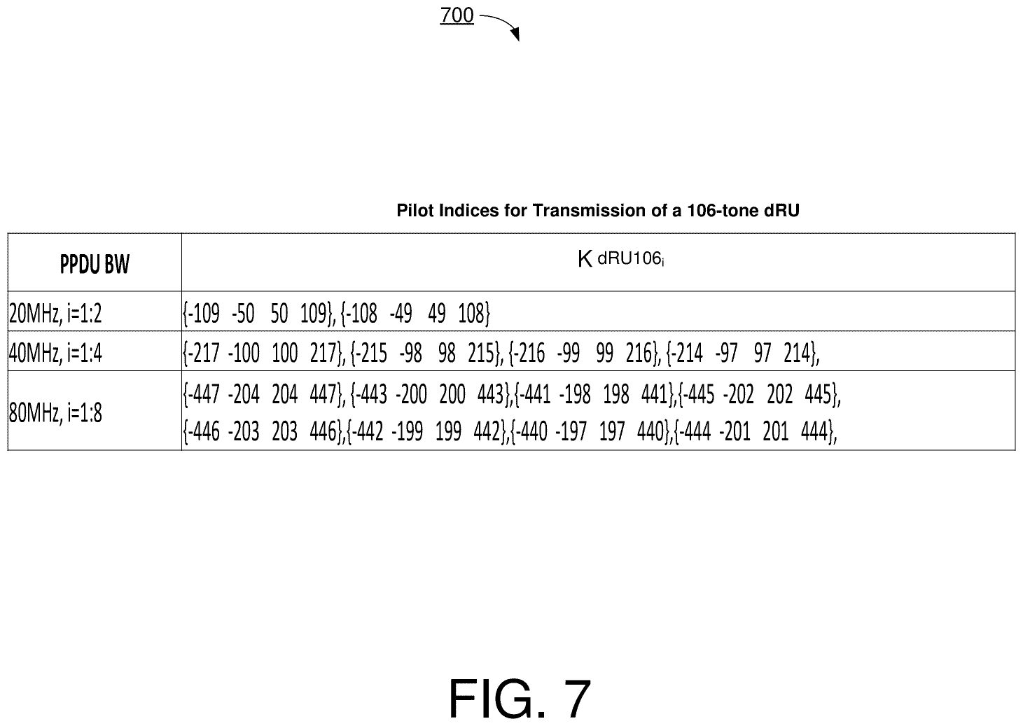

FIG. 6 illustrates an example scenario 600 of a pilot tone design for a 106-tone dRU under a proposed scheme in accordance with the present disclosure. Following the same pilot tone design rules for a 52-tone dRU, the four pilot tones for each 106-tone dRU may be selected from the 7^{th}, (7+26)th or 33^{rd}, (22+2*26)th or 74^{th} and (22+3*26)th or 100^{th} tones of a dRU106. FIG. 7 illustrates an example design 700 of pilot tone indices for a 106-tone dRU under the proposed scheme.

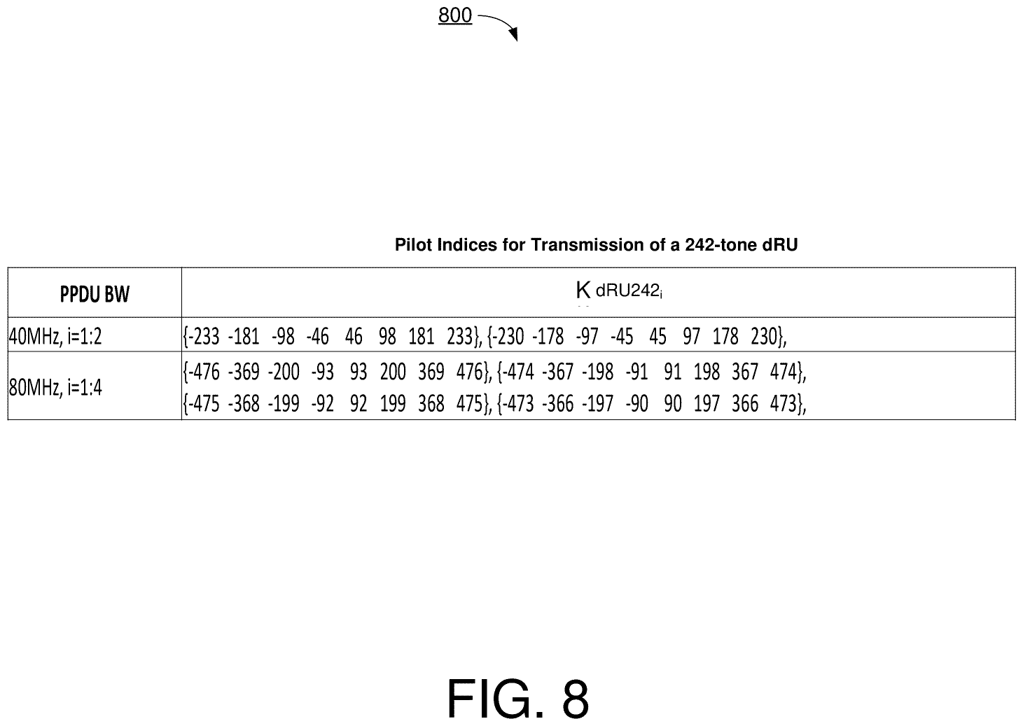

FIG. 8 illustrates an example design 800 of a pilot tone design for a 242-tone dRU under a proposed scheme in accordance with the present disclosure. Following the same pilot tone design rules for a 106-tone dRU, the eight pilot tones for each 242-tone dRU may be selected from the 7^{th}, (7+26)th or 33^{rd}, (22+2*26)th or 74^{th}, (22+3*26)th or 100^{th}, (7+136)th or 143^{rd}, (7+26+136)th or 169^{th}, (22+2*26+136)th or 210^{th} and (22+3*26+136)th or 236^{th} tones of a dRU242.

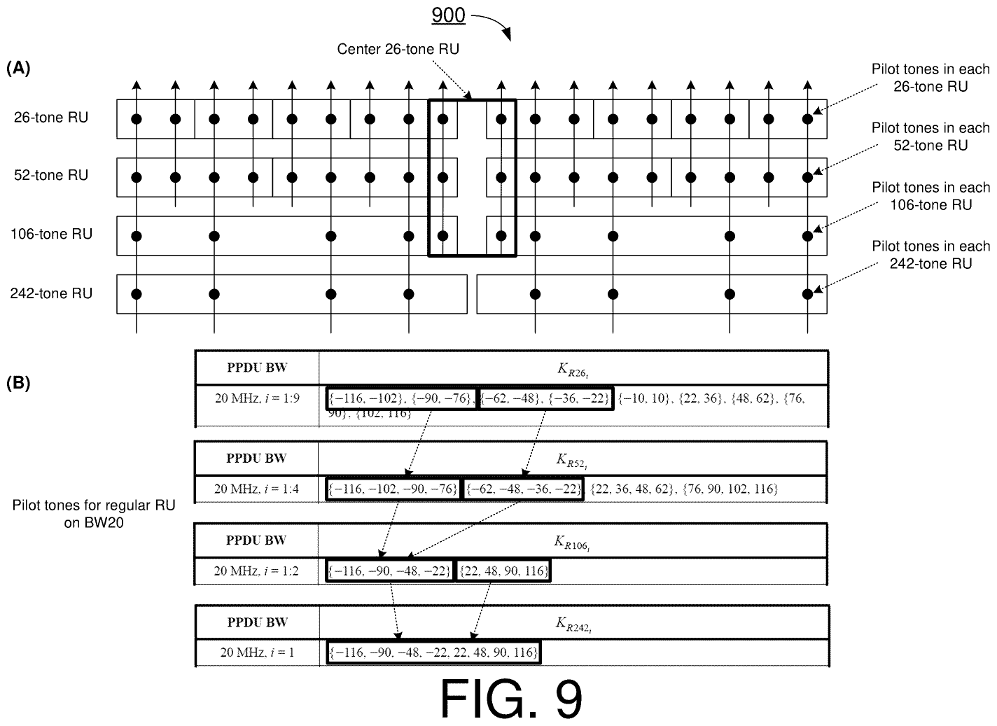

FIG. 9 illustrates an example design 900 of a hierarchical structure used in pilot tone designs for dRUs under a proposed scheme in accordance with the present disclosure. In part (A) of FIG. 9, pilot tones of each of a 26-tone rRU, a 52-tone rRU, a 106-tone rRU and a 242-tone rRU are shown as black dots and may be used as pilot tones for a 26-tone dRU, a 52-tone dRU, a 106-tone dRU and a 242-tone dRU. Part (B) of FIG. 9 shows indices of pilot tones of a rRU on BW20.

Under the proposed scheme, similar with the hierarchical structure of pilot tones for a rRU, the design rules regarding pilot tones for dRUs are listed below. Firstly, four pilot tones of a 52-tone dRU may include pilot tones from two corresponding 26-tone dRUs (e.g., with two pilot tones from each 26-tone dRU). For instance, four pilot tones of a 52-tone dRU1 may be built from two pilot tones from a 26-tone dRU1 and two pilot tones from a 26-tone dRU2 and the like. Secondly, four pilot tones of a 106-tone dRU may include pilot tones from two corresponding 52-tone dRUs (e.g., with two pilot tones from each 52-tone dRU). For instance, four pilot tones of a 106-tone dRU1 may be built from two pilot tones from a 52-tone dRU1 and two pilot tones from a 52-tone dRU2 and the like. Thirdly, eight pilot tones of a 242-tone dRU may include pilot tones from two corresponding 106-tone dRUs (e.g., with four pilot tones from each 106-tone dRU). For instance, eight pilot tones of a 242-tone dRU1 may be built from four pilot tones from a 106-tone dRU1 and four pilot tones from a 106-tone dRU2 and the like. Fourthly, sixteen pilot tones of a 484-tone dRU may include pilot tones from two corresponding 242-tone dRUs (e.g., with eight pilot tones from each 242-tone dRU). For instance, sixteen pilot tones of a 484-tone dRU1 may be built from eight pilot tones from a 242-tone dRU1 and eight pilot tones from a 242-tone dRU2 and the like.

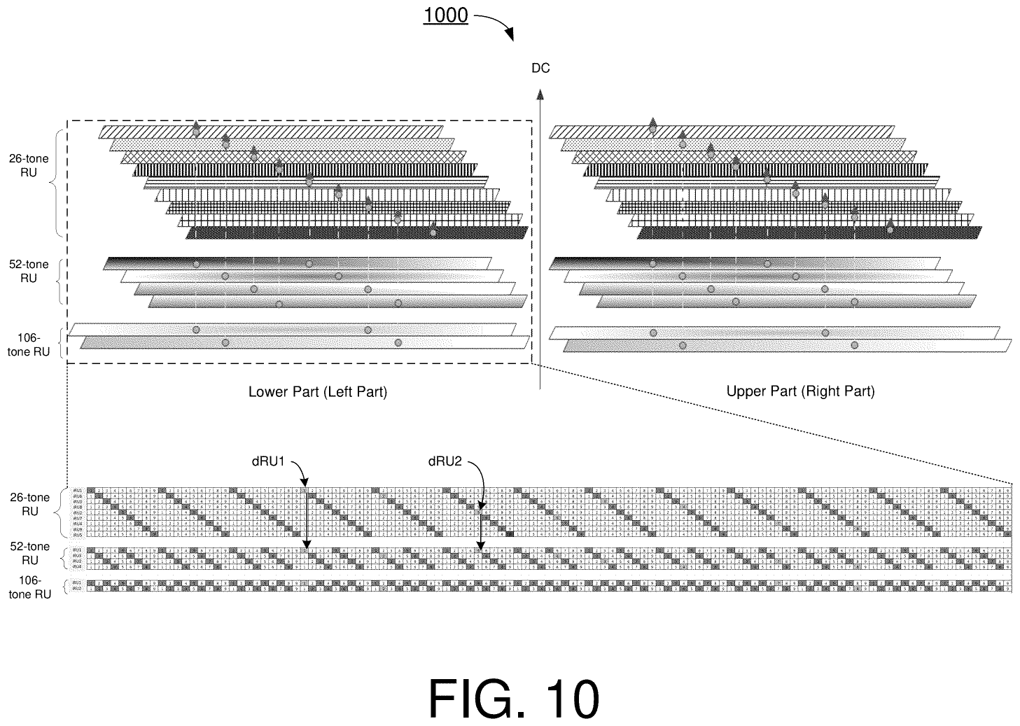

FIG. 10 illustrates an example design 1000 of a hierarchical structure-based pilot tone design for dRUs under a proposed scheme in accordance with the present disclosure. Design 1000 shows an alternative way of pilot tone assignment to maintain the hierarchical structure and achieve better pilot tone separation for dRUs (e.g., dRU26 and dRU52 and dRU106) to avoid the problem of dRU pilots are “squeezed in clusters” at receiver side.

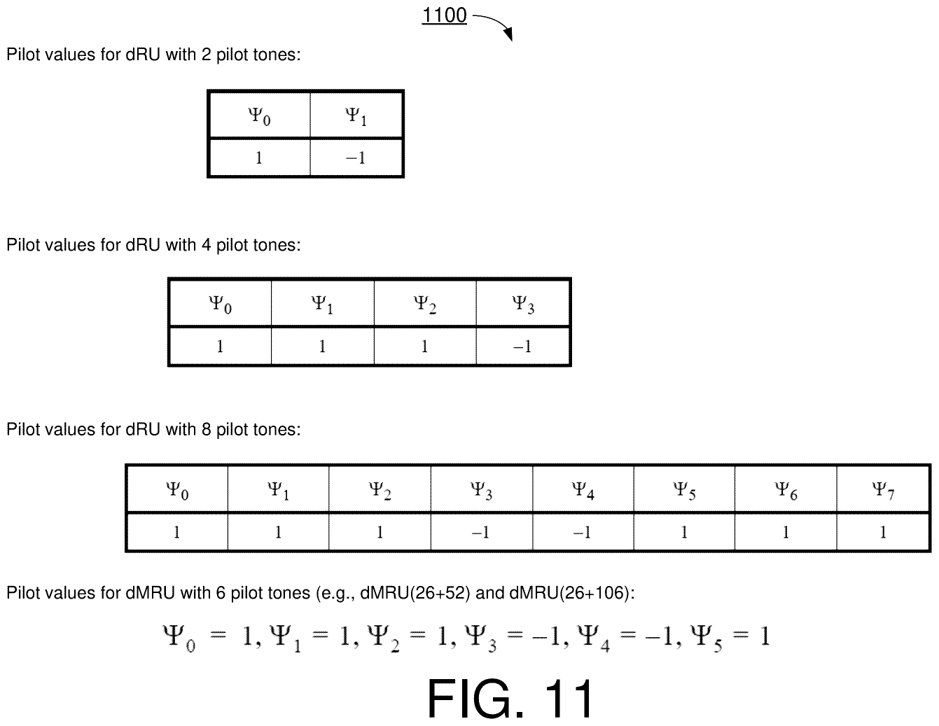

Under a proposed scheme in accordance with the present disclosure, pilot tone values (or pilot values) for rRUs may be reused for dRU pilot tones. FIG. 11 illustrates an example design 1100 under the proposed scheme. Referring to FIG. 11, proposed pilot values for dRUs having two pilot tones, four pilot tones and eight pilot tones are shown. Additionally, FIG. 11 shows example pilot values for dMRUs with six pilot tones (e.g., dMRU (26+52) and dMRU (26+106)).

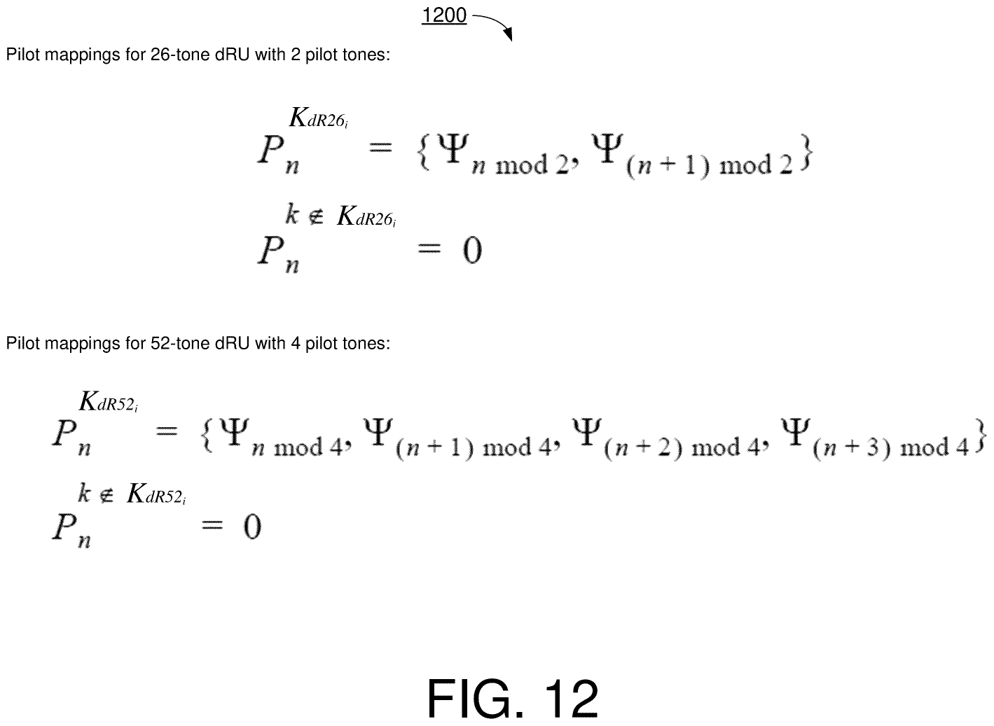

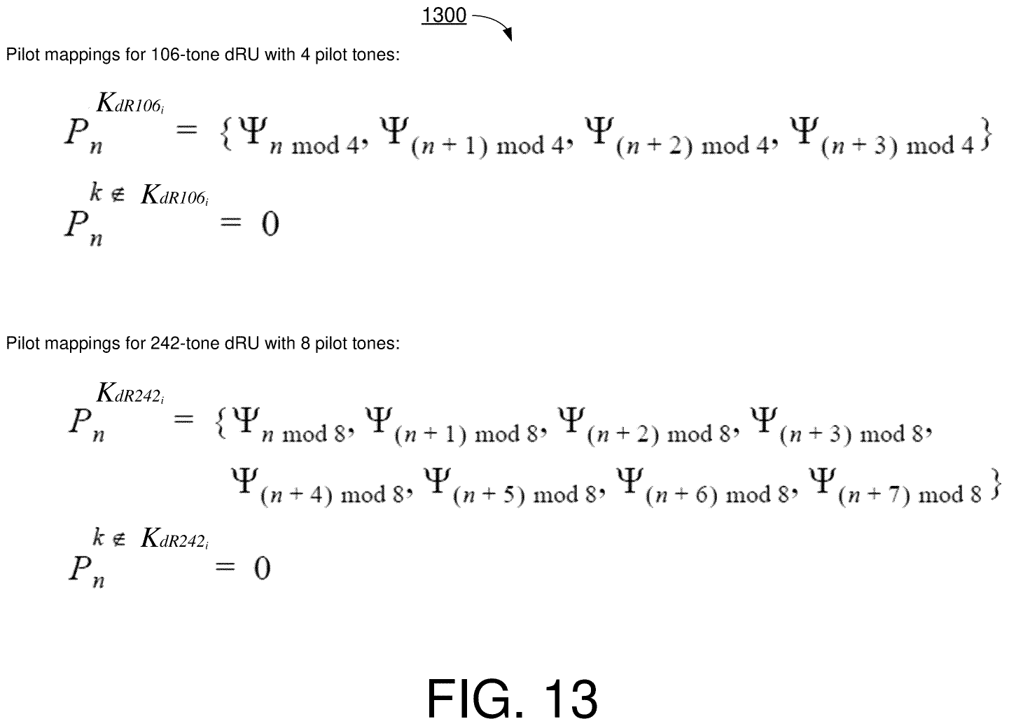

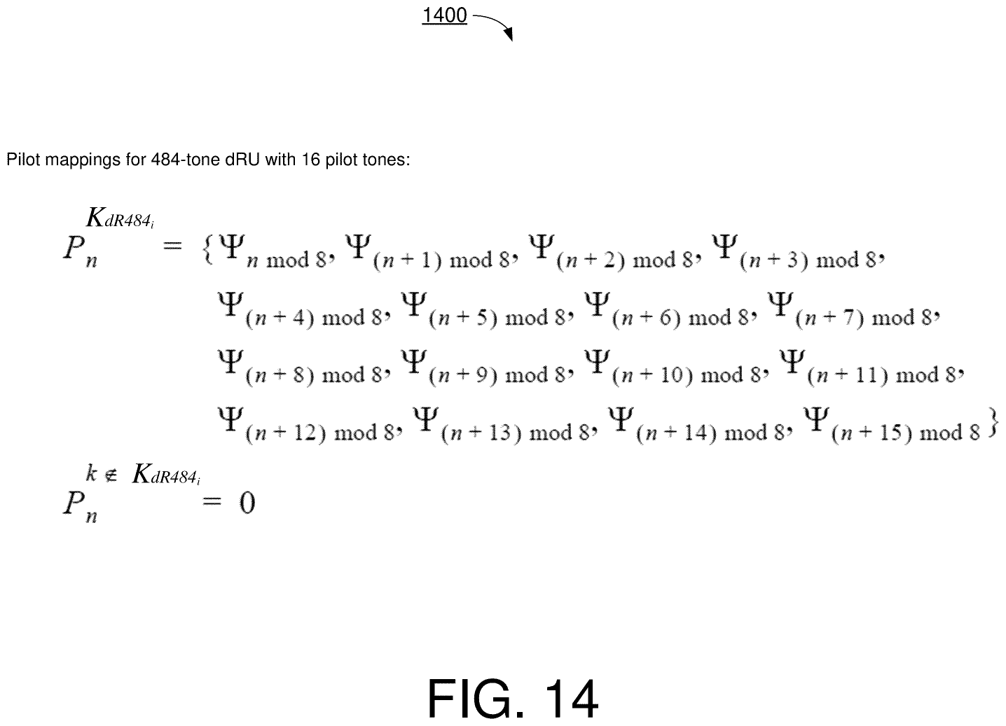

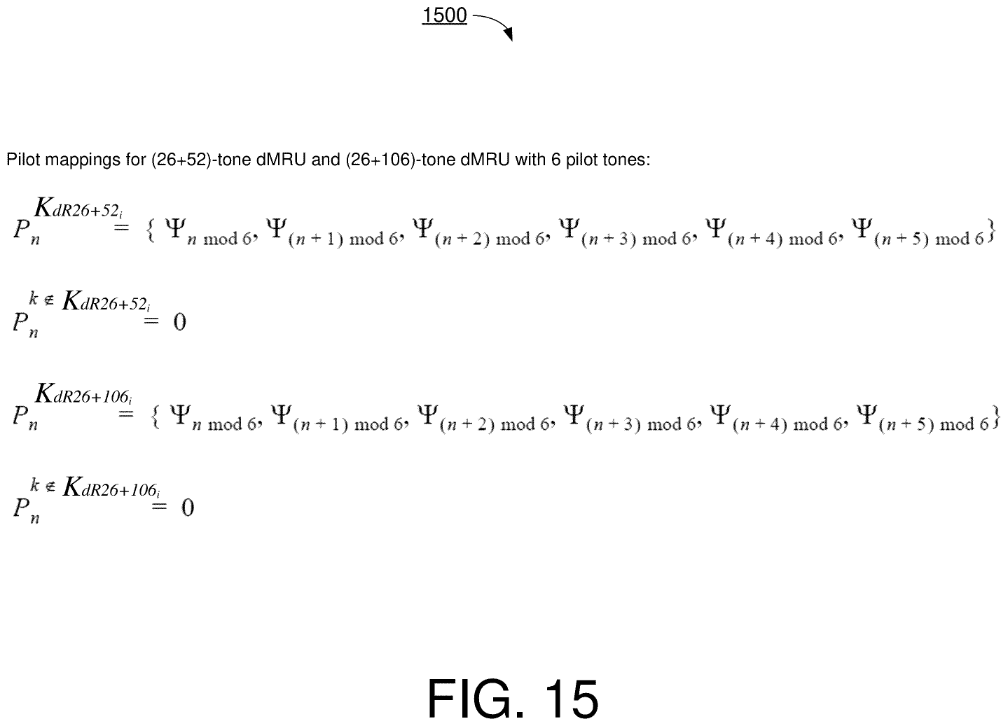

Under a proposed scheme in accordance with the present disclosure, pilot mapping for rRUs may be reused for dRU pilot mapping. FIG. 12, FIG. 13, FIG. 14 and FIG. 15 illustrate example designs 1200, 1300, 1400 and 1500 under the proposed scheme. Referring to FIG. 12, proposed pilot mappings for dRUs having two pilot tones and four pilot tones are shown. For instance, the proposed pilot mappings may be used for a 26-tone dRU with two pilot tones and a 52-tone dRU with four pilot tones, respectively. Referring to FIG. 13, proposed pilot mappings for dRUs having four pilot tones and eight pilot tones are shown. For instance, the proposed pilot mappings may be used for a 106-tone dRU with four pilot tones and a 242-tone dRU with eight pilot tones, respectively. Referring to FIG. 14, proposed pilot mappings for dRUs having sixteen pilot tones are shown. For instance, the proposed pilot mapping may be used for a 484-tone dRU with sixteen pilot tones. Referring to FIG. 15, proposed pilot mappings for dMRUs having six pilot tones are shown. For instance, the proposed pilot mappings may be used for a (26+52)-tone dMRU and a (26+106)-tone dMRU with six pilot tones.

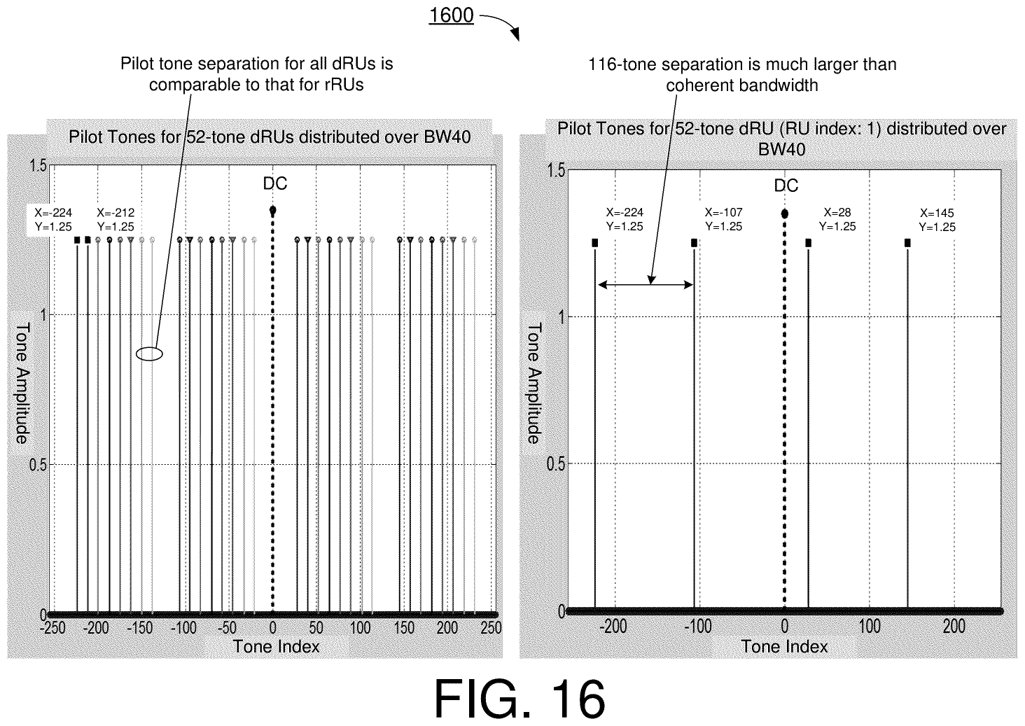

Under a proposed scheme in accordance with the present disclosure, there may be two options for pilot tone design for dRUs. FIG. 16 illustrates an example scenario 1600 under the proposed scheme. Under a first approach of Option 2 (Option 2A), pilot tone separations may be maximized for the overall dRUs to achieve near-evenly distribution of pilot tones. Under a second approach of Option 2 (Option 2B), perfect-evenly distribution of pilot tones may be achieved for dRU26 and near-evenly distribution of pilot tones may be achieved for dRUs of other sizes, with a sufficiently large overall pilot tone separations maintained to avoid narrow-band interference (NBI) at AP receiver side. Both Option 2A and Option 2B may preserve the hierarchical structure of pilot tones used for rRUs. Under the proposed scheme, the pilot tones for a 26-tone dRU may be defined first and then pilot tones for dRUs of all other sizes may be generated from the pilot tones of the 26-tone dRU based on the hierarchical structure of pilot tones similar to that for rRUs. Under the proposed scheme, the first tone of each dRU may not be used for pilot tones, and the tones of each dRU next to the DC (DC tone) may not be used as pilot tones. Advantageously, the distance between pilot tones of each dRU may be much larger than the coherent bandwidth, as shown in FIG. 16, wherein X axis is tone index and Y axis is tone amplitude.

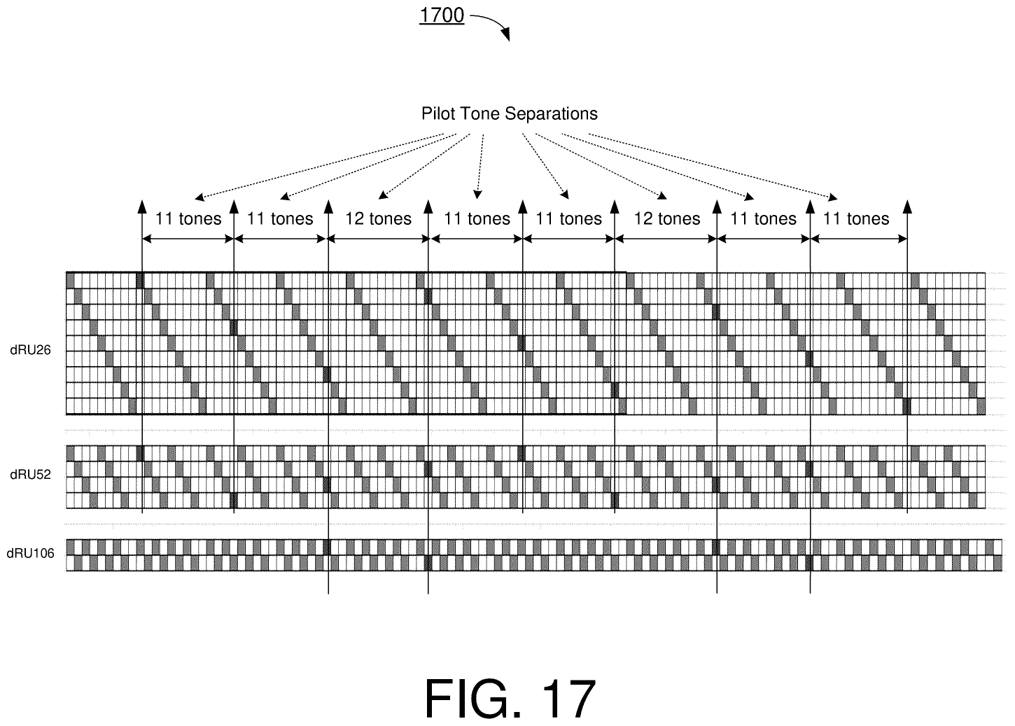

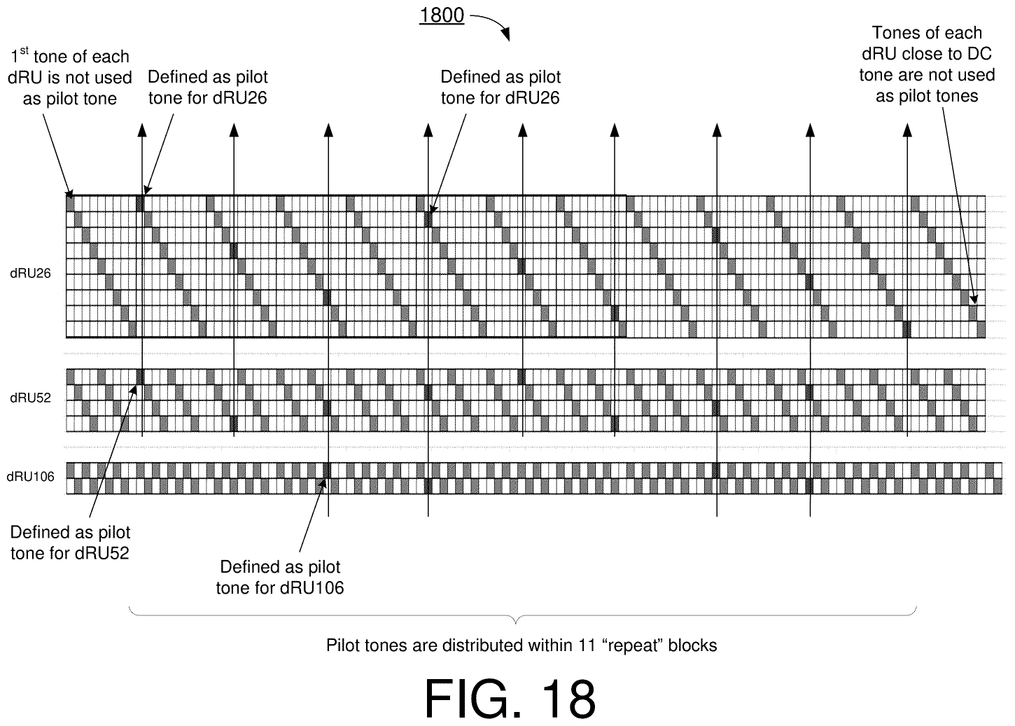

FIG. 17 illustrates an example scenario 1700 of pilot tone design for dRUs on BW20 under Option 2A. FIG. 18 illustrates an example scenario 1800 of pilot tone locations for dRUs on BW20 under Option 2A. It is noteworthy that each of scenario 1700 and scenario 1800 merely shows a half portion of tone distribution on BW20 (e.g., either the lower part or the upper part). As shown in FIG. 17 and FIG. 18, the pilot tones are near-evenly distributed over BW20 for dRU26, dRU52 and dRU106 to avoid the issue of pilot tones being squeezed in cluster(s). Also, there is a minimum distance between pilot tones (e.g., 11 tones or 12 tones) for overall pilot tones, which is comparable to that for rRUs. Referring to FIG. 18, the first tone of each dRU is not used as pilot tone, and the tones of each dRU close to the DC tone are not used as pilot tones. In the example shown in FIG. 18, the pilot tones are distributed within eleven “repeat” blocks.

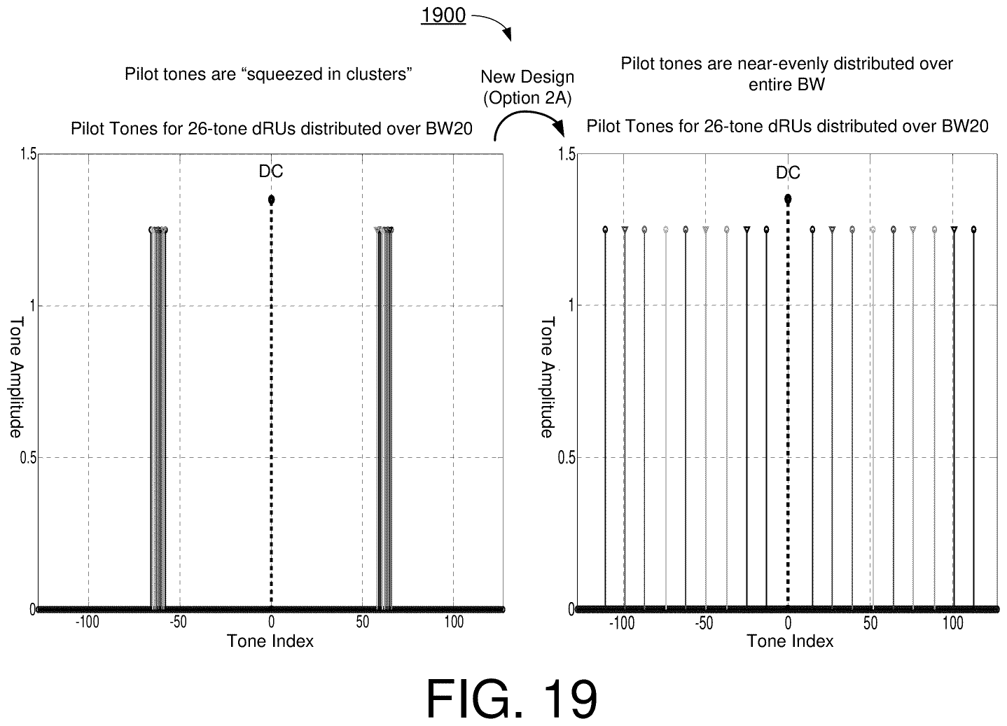

FIG. 19 illustrates an example scenario 1900 of pilot tone distribution for dRU26 on BW20 under Option 2A. As shown on the left side of FIG. 19, distribution of pilot tones of a 26-tone dRU without implementing the proposed scheme (Option 2A) may result in the pilot tones being squeezed in clusters (e.g., by using design Option 1). As shown on the right side of FIG. 19, pilot tones of a 26-tone dRU may be near-evenly distributed over an entire bandwidth of BW20 under Option 2A.

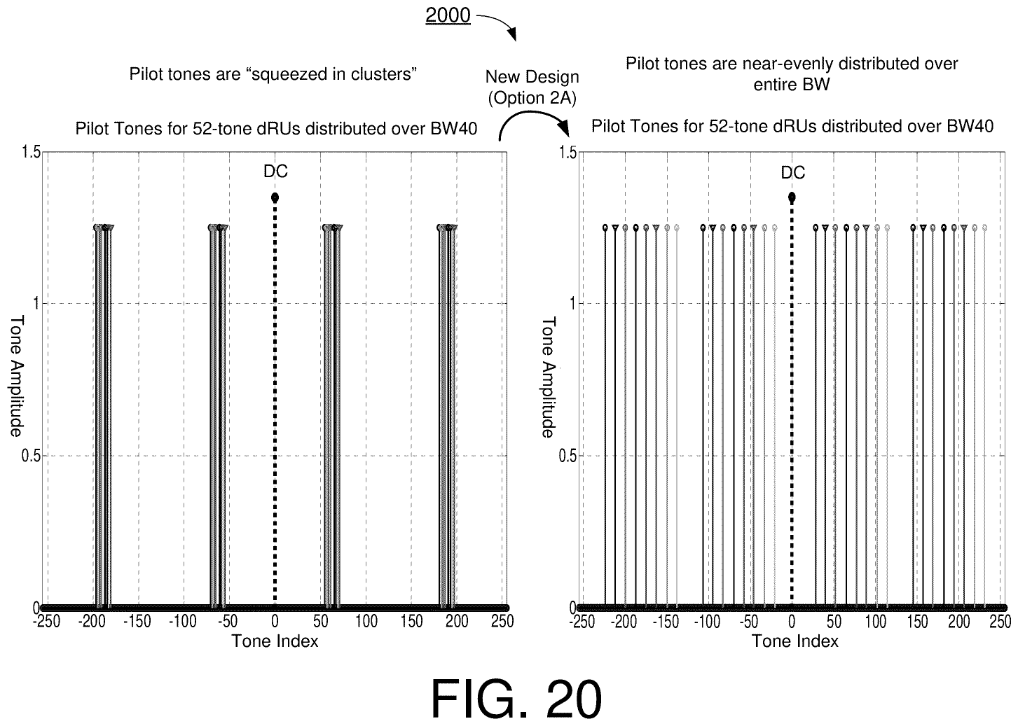

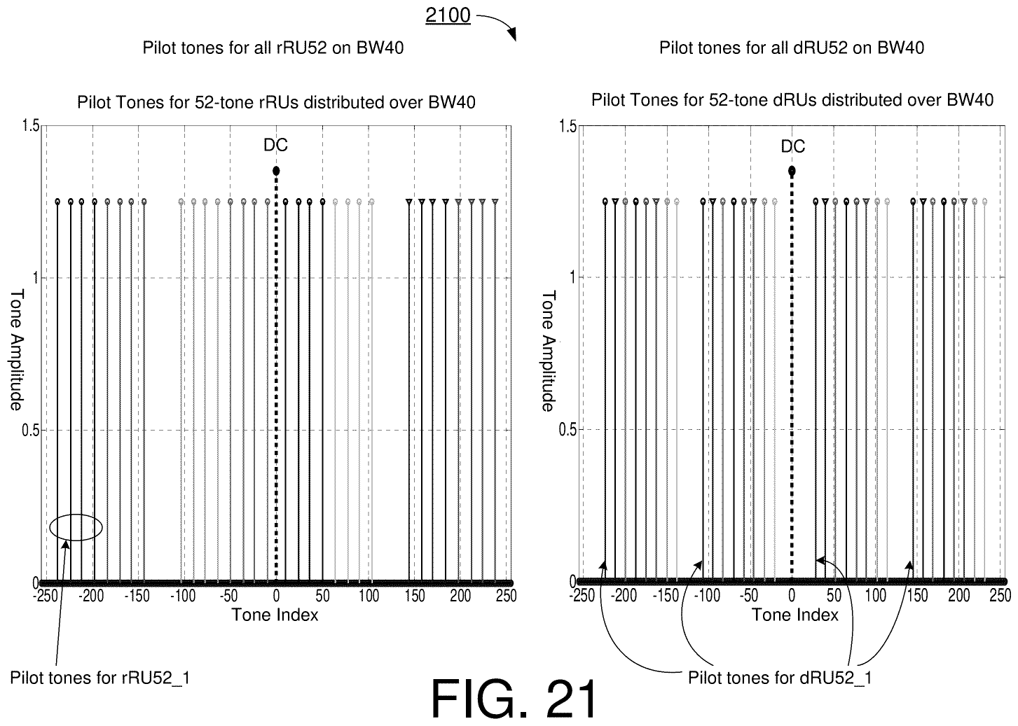

FIG. 20 illustrates an example scenario 2000 of pilot tone distribution for dRU52 on BW40 under Option 2A. As shown on the left side of FIG. 20, distribution of pilot tones of a 52-tone dRU without implementing the proposed scheme (Option 2A) may result in the pilot tones being squeezed in clusters (e.g., by using design Option 1). As shown on the right side of FIG. 20, pilot tones of a 52-tone dRU may be near-evenly distributed over an entire bandwidth of BW40 under Option 2A. FIG. 21 illustrates an example scenario 2100 of a comparison of pilot tones. In scenario 2100, pilot tones of a rRU52 on BW40 and pilot tones of a dRU52 on BW40 are compared. As can be seen, instead of being squeezed in a cluster for dRU pilot design Option 1, similar to rRU52, the pilot tones of dRU52 are distributed near-evenly over the entire bandwidth of BW40 under Option 2A.

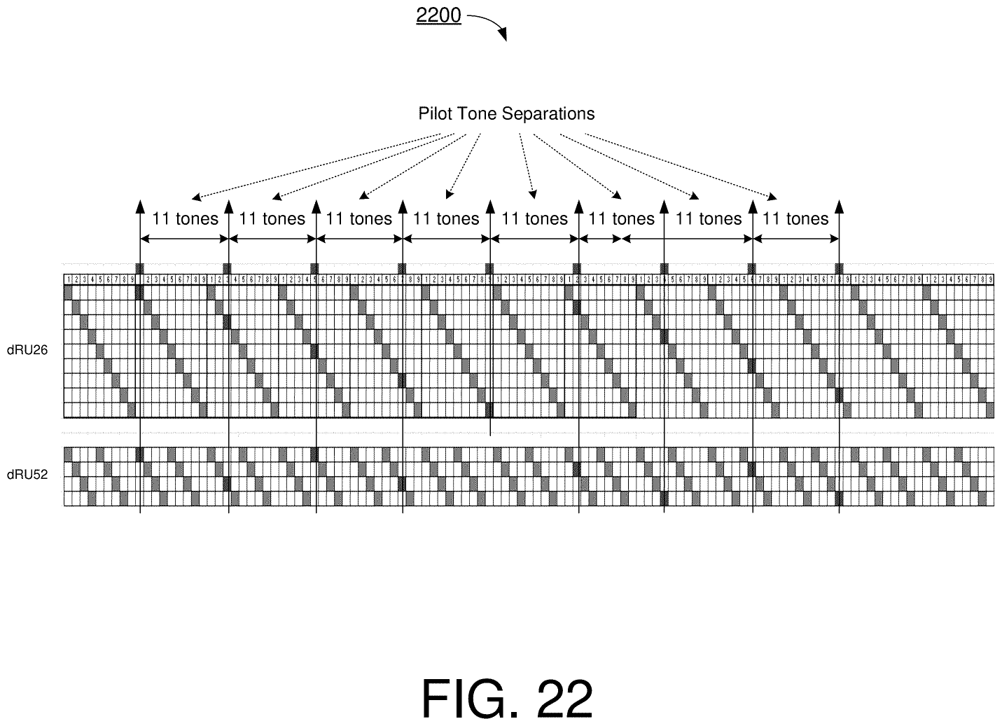

FIG. 22 illustrates an example scenario 2200 of pilot tone design for dRUs on BW20 under Option 2B. It is noteworthy that scenario 1700 merely shows a half portion of tone distribution on BW20 (e.g., either the lower part or the upper part). As shown in FIG. 22, the pilot tones are perfect-evenly distributed over BW20 for dRU26 and near-evenly distributed for dRUs of other sizes to maintain a sufficiently large overall pilot tone separation to avoid the issue of pilot tones being squeezed in cluster(s). Also, there is a minimum distance between pilot tones (e.g., 11) for overall pilot tones, which is comparable to that for rRUs. It is also noteworthy that the pilot tones for dRU26 under Option 2B may be selected based on “sub-sampling by 11” for 26-tone dRU.

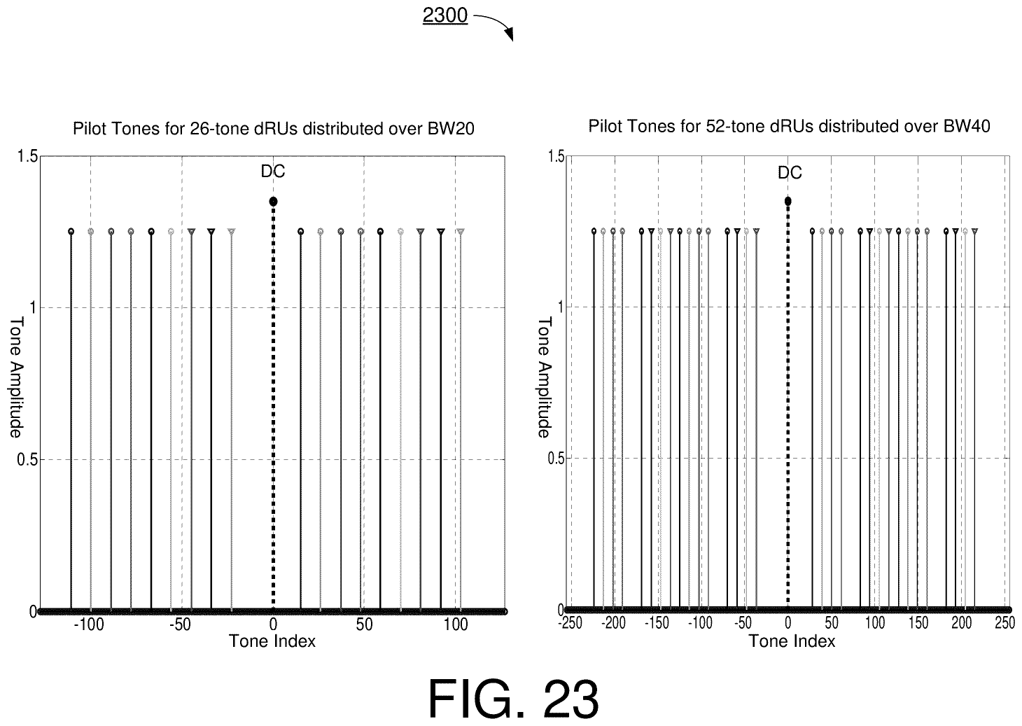

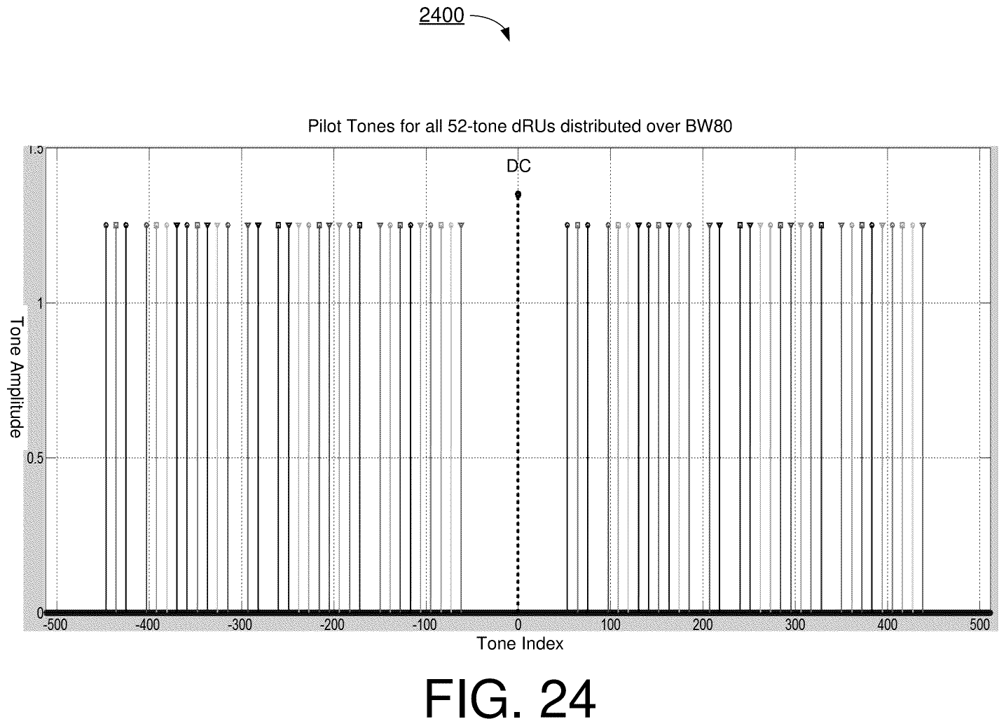

FIG. 23 illustrates an example scenario 2300 of pilot tone locations for dRU26 on BW20 and dRU52 on BW40 under Option 2B. Specifically, the left side of FIG. 23 shows pilot tones of a 26-tone dRU distributed over BW20 under Option 2B. The right side of FIG. 23 shows pilot tones of a 52-tone dRU distributed over BW40 under Option 2B. FIG. 24 illustrates an example scenario 2400 of pilot tone locations for dRU52 on BW80 under Option 2B.

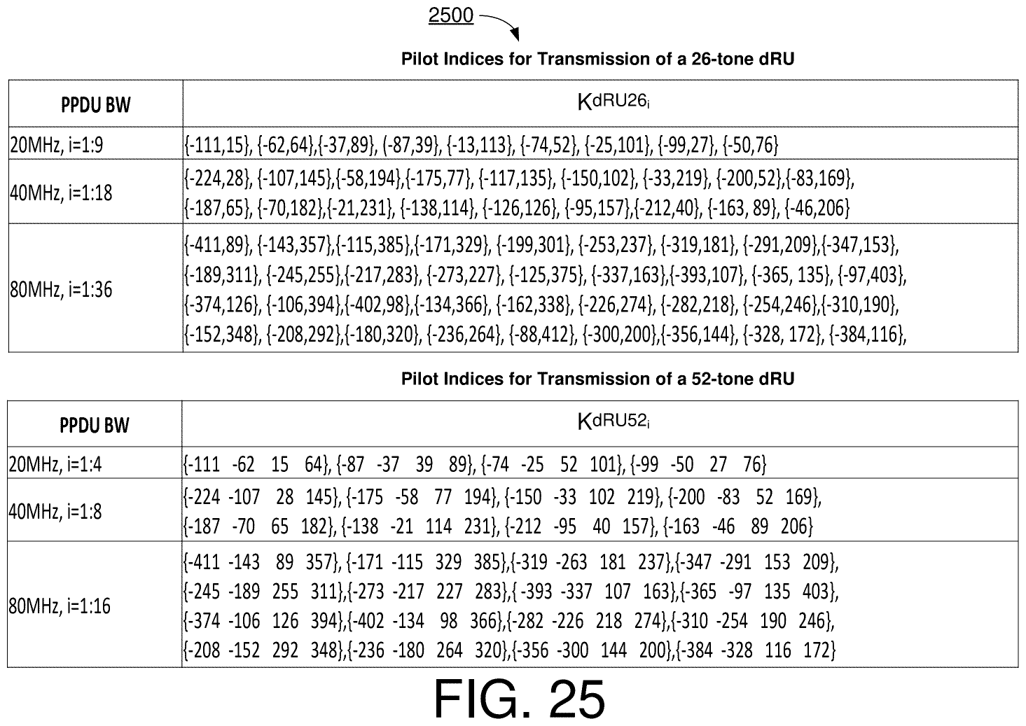

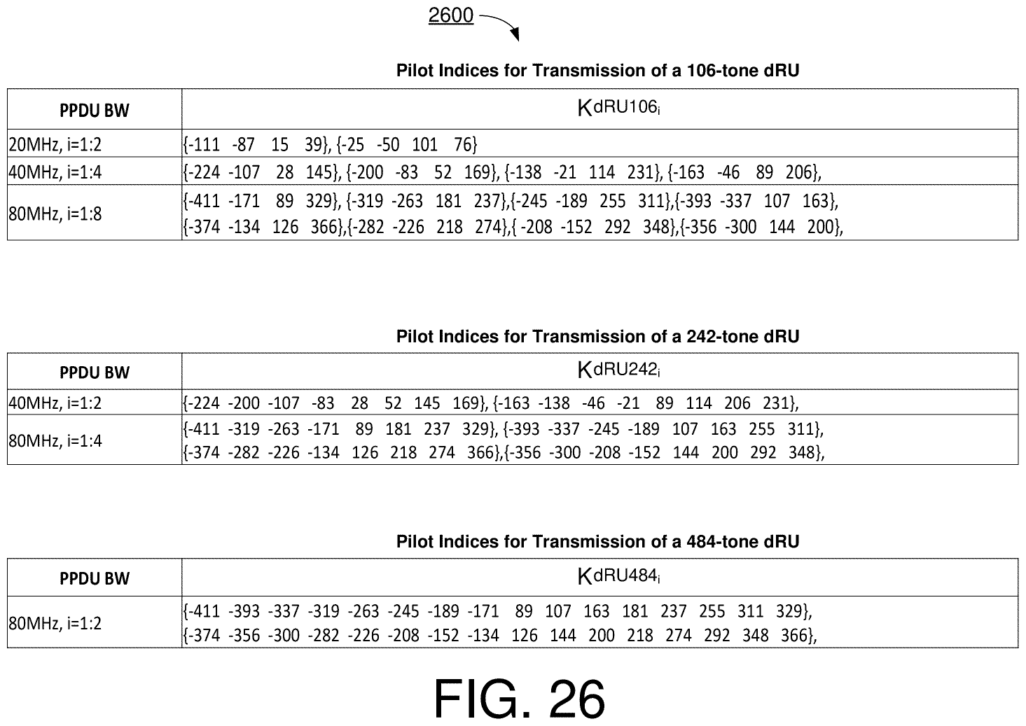

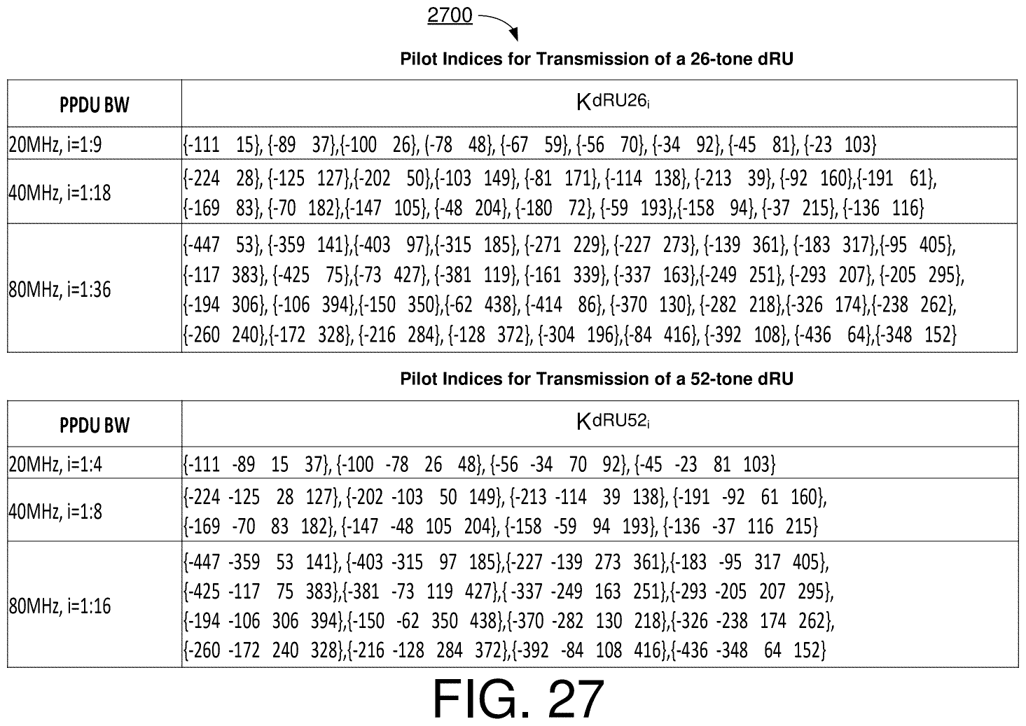

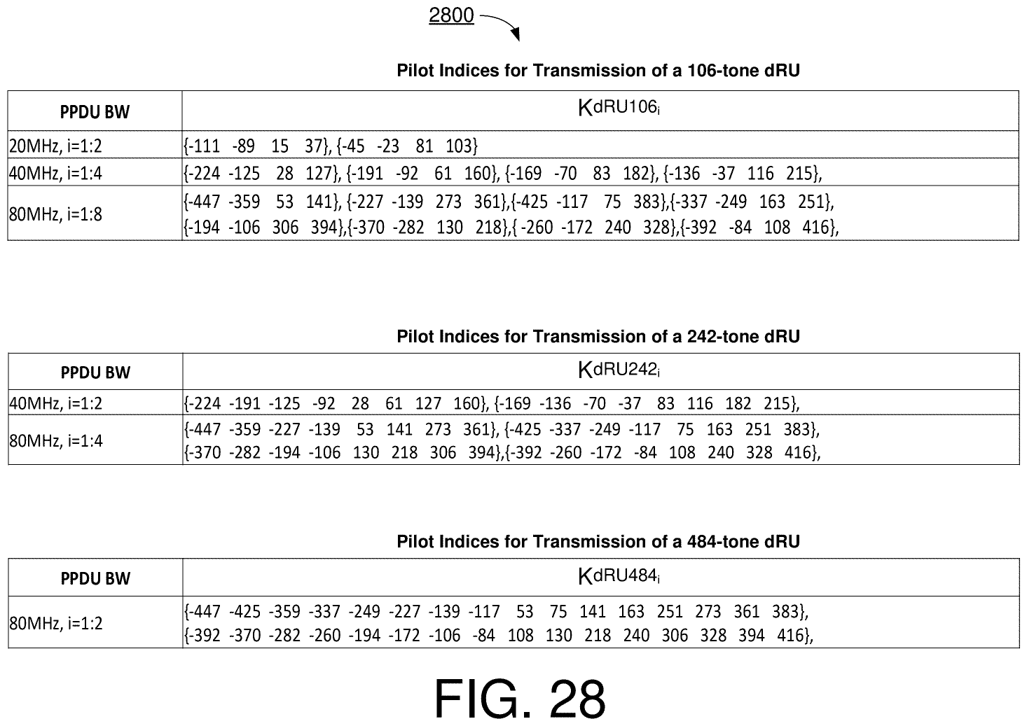

FIG. 25 illustrates an example design 2500 of pilot tones for dRU26 and dRU52 on BW20, BW40 and BW80 under Option 2A. FIG. 26 illustrates an example design 2600 of pilot tones for dRU106, dRU242 and dRU484 on BW20, BW40 and BW80 under Option 2A. FIG. 27 illustrates an example of an alternative design 2700 of pilot tones for dRU26 and dRU52 on BW20, BW40 and BW80 under Option 2B. FIG. 28 illustrates an example of alternative design 2800 of pilot tones for dRU106, dRU242 and dRU484 on BW20, BW40 and BW80 under Option 2B.

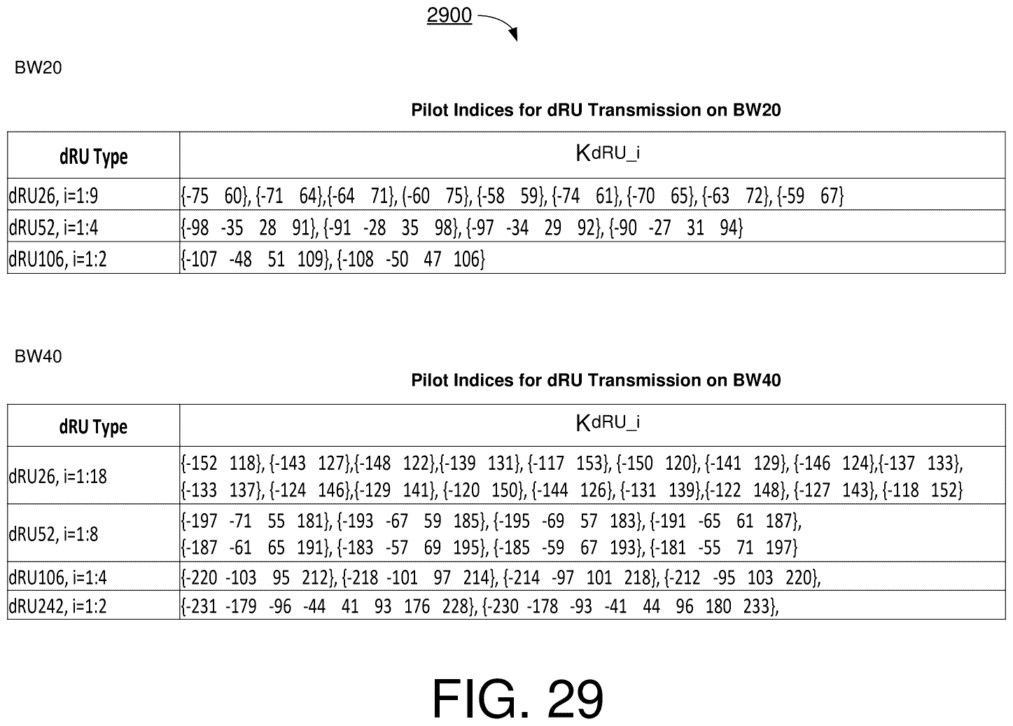

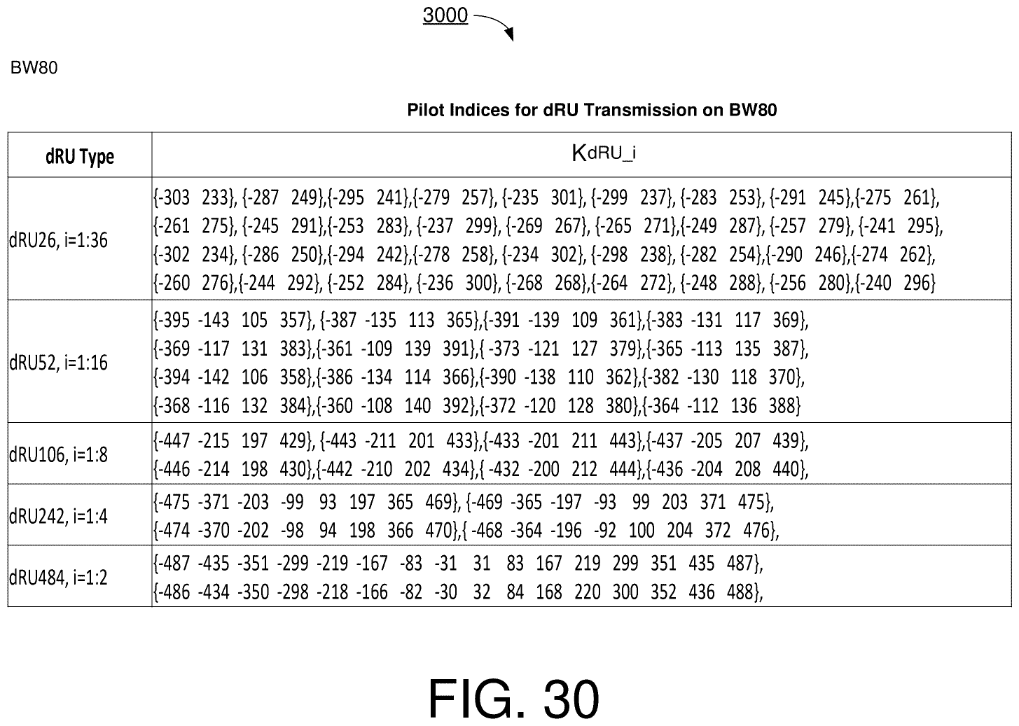

Under a proposed scheme in accordance with the present disclosure, based on the dRU tone plan described above, dRU pilot tone indices may be defined by using a “relative pilot position”-based dRU pilot tone design under Option 1. FIG. 29 illustrates an example design 2900 of pilot tone indices for transmission of dRU26, dRU52 and dRU106 on BW20 and for transmission of dRU26, dRU52, dRU106 and dRU242 on BW40. FIG. 30 illustrates an example design 3000 of pilot tone indices for transmission of dRU26, dRU52, dRu106, dRU242 and dRU484 on BW80.

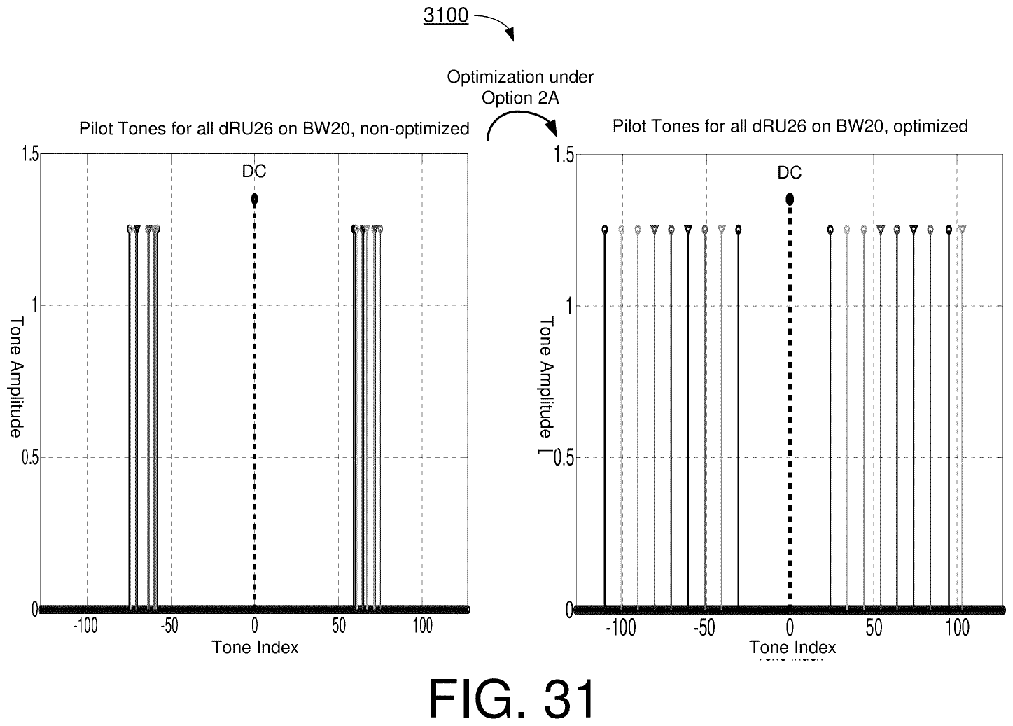

Under a proposed scheme in accordance with the present disclosure, dRU pilot tone design of Option 1 may be optimized by applying a shift or adjustment on relative pilot position(s) to avoid the issue of pilot tones being squeezed in cluster(s). The shift or adjustment on the relative pilot position(s) may be based on the starting index of each RU (herein interchangeably referred to as “RUₛₜₐᵣₜ”). For instance, the optimized relative position for dRU26 on BW20 may be generated by applying a per-RU shift based on RUₛₜₐᵣₜ as follows: [7, 21]+RUₛₜₐᵣₜ (r)−4, where [7, 21] denotes the relative pilot positions of rRU26. FIG. 31 illustrates an example scenario 3100 of optimization of pilot tone design for dRU26 under Option 1 optimization of the proposed scheme.

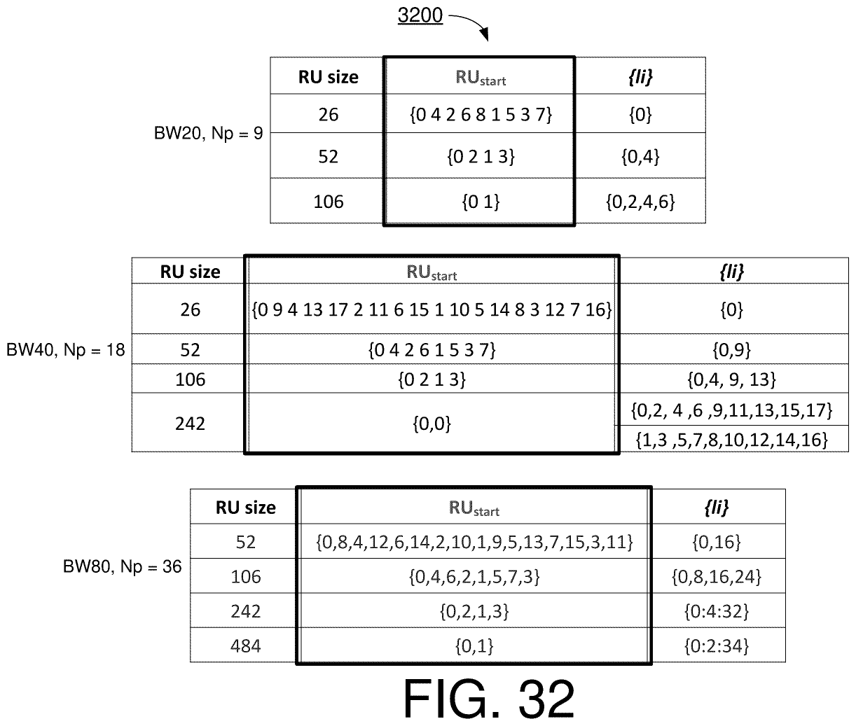

FIG. 32 illustrates an example design 3200 of design parameters for dRU pilot tones on BW20, BW40 and BW80 under Option 1 optimization. In design 3200, regarding the dRU tone pattern repetition period (Np, in term of number of tones), Np=9 for BW20, Np=18 for BW80, and Np=36 for BW80. Under the proposed scheme, the parameter RUₛₜₐᵣₜ represents the relative position of each dRU first tone index or the permutation of dRU starting tone index. The parameter RUₛₜₐᵣₜ may be used to adjust pilot tone position for each dRU to avoid the issue of pilot tones being squeezed in cluster(s).

Under a proposed scheme in accordance with the present disclosure with respect to relative pilot position and RUₛₜₐᵣₜ based dRU pilot tone design, relative pilot positions may include the following: (i) [7, 21] for all dRU26 on BW20 and BW40; (ii) [6, 20, 32, 46] for all dRU52 on BW20, BW40 and BW80; (iii) [6, 32, 74, 100] for all dRU106 on BW20, BW40 and BW80; (iv) [7, 33, 75, 101, 141, 167, 209, 235] for all dRU242 on BW40 and BW80; and (v) [7, 33, 75, 101, 141, 167, 209, 235, 250, 276, 318, 344, 384, 410, 452, 478] for all dRU484 on BW80. The relative pilot position vector may be denoted as Vᵣₚ, which may be used to define the optimized pilot tones for dRUs as follows: (i) Vᵣₚ=[7, 21] for dRU26; (ii) Vᵣₚ=[6, 20, 32, 46] for dRU52; (iii) Vᵣₚ=[6, 32, 74, 100] for dRU106; (iv) Vᵣₚ=[7, 33, 75, 101, 141, 167, 209, 235] for dRU242; and (v) Vᵣₚ=[7, 33, 75, 101, 141, 167, 209, 235, 250, 276, 318, 344, 384, 410, 452, 478] for dRU484. It is noteworthy that the alternative Vᵣₚ may be used for the pilot tone design. For instance, Vᵣₚ=[6, 20] for dRU26; Vᵣₚ=[6, 20, 32, 46]+1 for dRU52; Vᵣₚ=[6, 32, 74, 100]+1 for dRU106; and Vᵣₚ=[7, 33, 75, 101, 141, 167, 209, 235]+1 for dRU242.

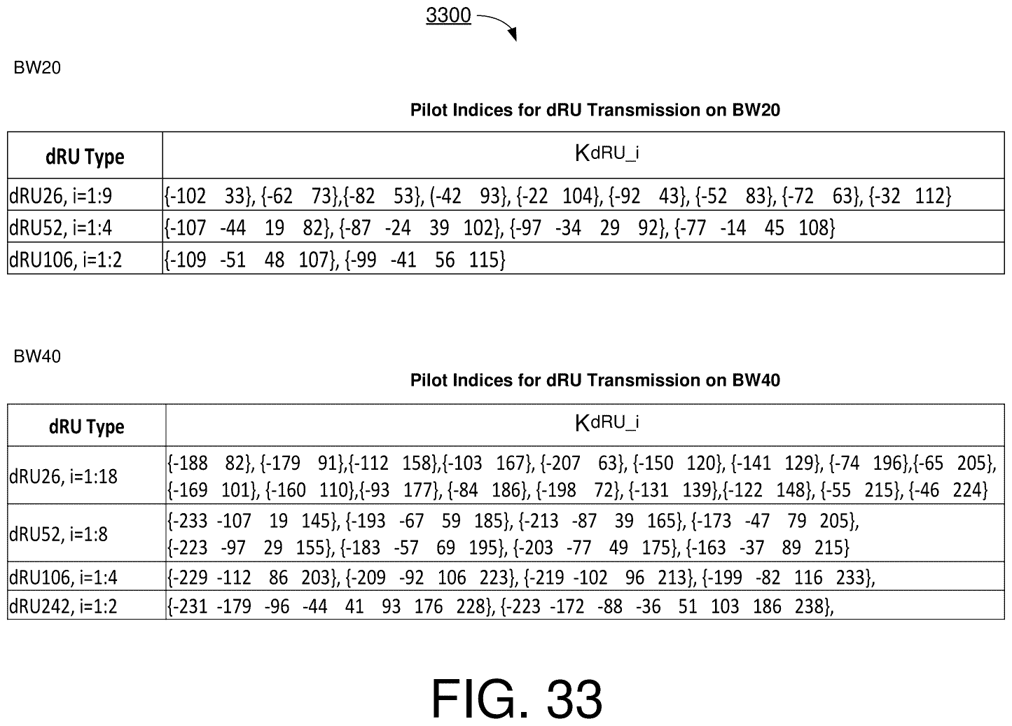

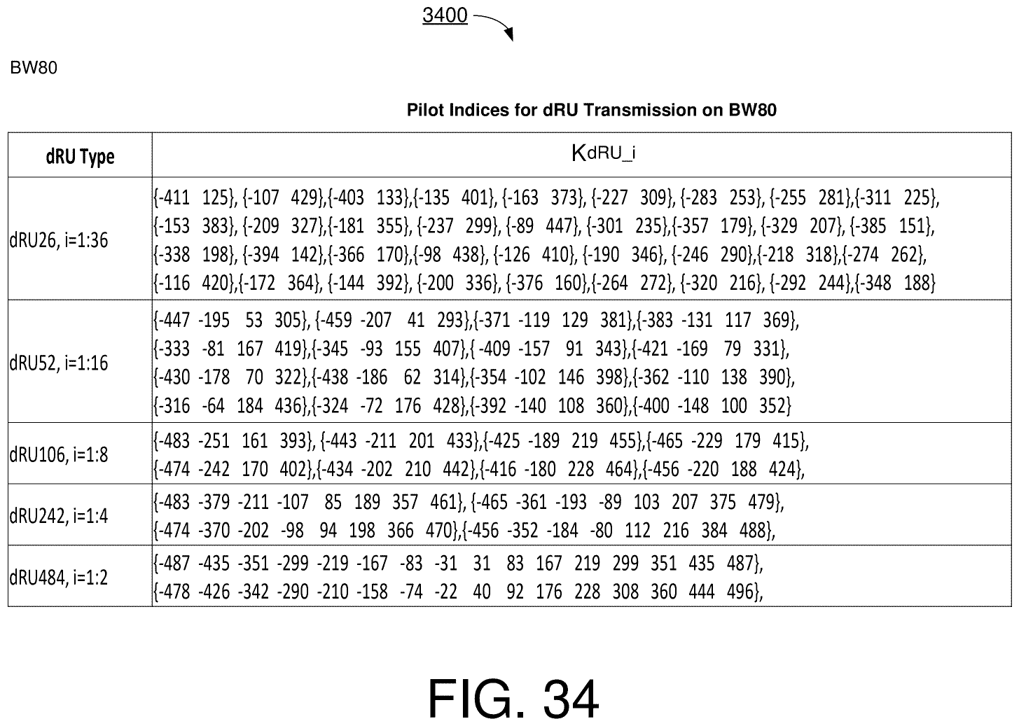

Under the proposed scheme, the adjustment or shift may be performed on the relative pilot position Vᵣₚ for each dRU to generate the adjusted or shifted relative pilot tone positions as sVᵣₚ=Vᵣₚ+Sᵣₚ(r), where: (i) Sᵣₚ(r)=mod (RUₛₜₐᵣₜ(r)+1, 9)−4 for dRU26 on BW40 and for dRU52 on BW80; (ii) Sᵣₚ(r)=RUₛₜₐᵣₜ(r)−4 for dRU26 on BW20, dRU52 on BW40 and dRU106 on BW80; (iii) Sᵣₚ(r)=(RUₛₜₐᵣₜ(r)−1)*2 for dRU52 on BW20, dRU106 on BW40 and dRU242 on BW80; and (iv) Sᵣₚ(r)=RUₛₜₐᵣₜ(r)*4 for dRU106 on BW20, dRU242 on BW40 and dRU 484 on BW80. It is noteworthy that, for dRU26 on BW20 and r=9, Vᵣₚ=[7, 23]; for dRU26 on BW40 and r=5, Vᵣₚ=[6, 20]; and for dRU26 on BW80 and r=1, Vᵣₚ=[6, 20]. After the adjusted or shifted relative pilot position sVᵣₚ is generated or otherwise obtained, the pilot tones for each dRU may be generated as dRU (sVᵣₚ), where dRU denotes the subcarrier indices for dRU of each size on BW20/40/80. FIG. 33 illustrates an example design 3300 of optimized pilot tones for transmission of dRU26, dRU52 and dRU106 on BW20 and for transmission of dRU26, dRU52, dRU106 and dRU242 on BW40. FIG. 34 illustrates an example design 3400 of optimized pilot tones for transmission of dRU26, dRU52, dRu106, dRU242 and dRU484 on BW80.

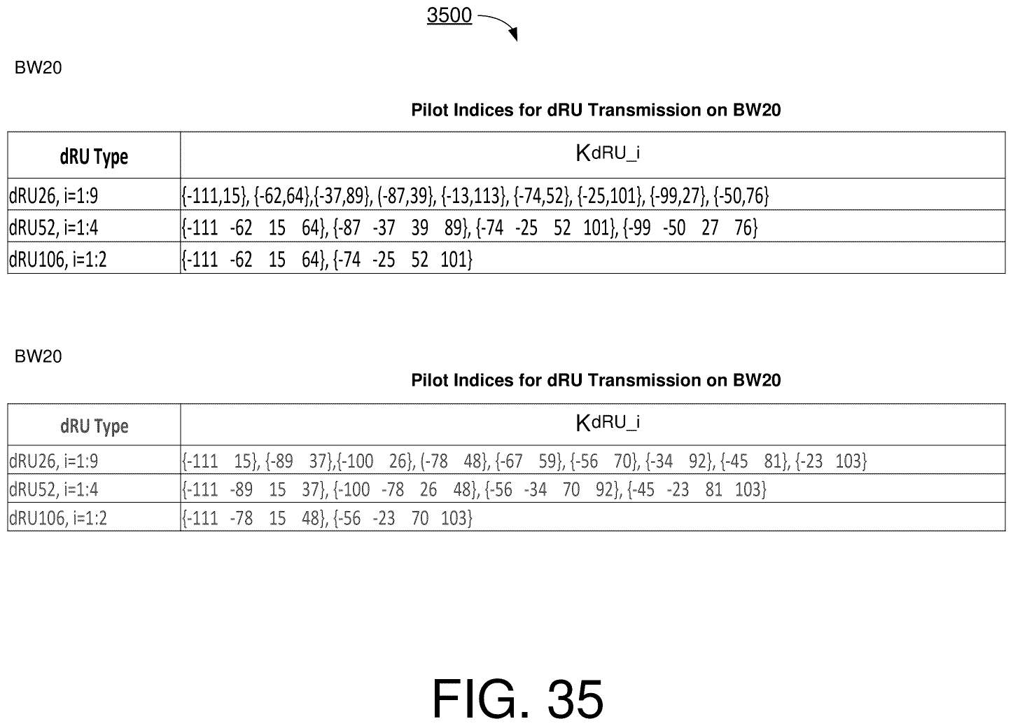

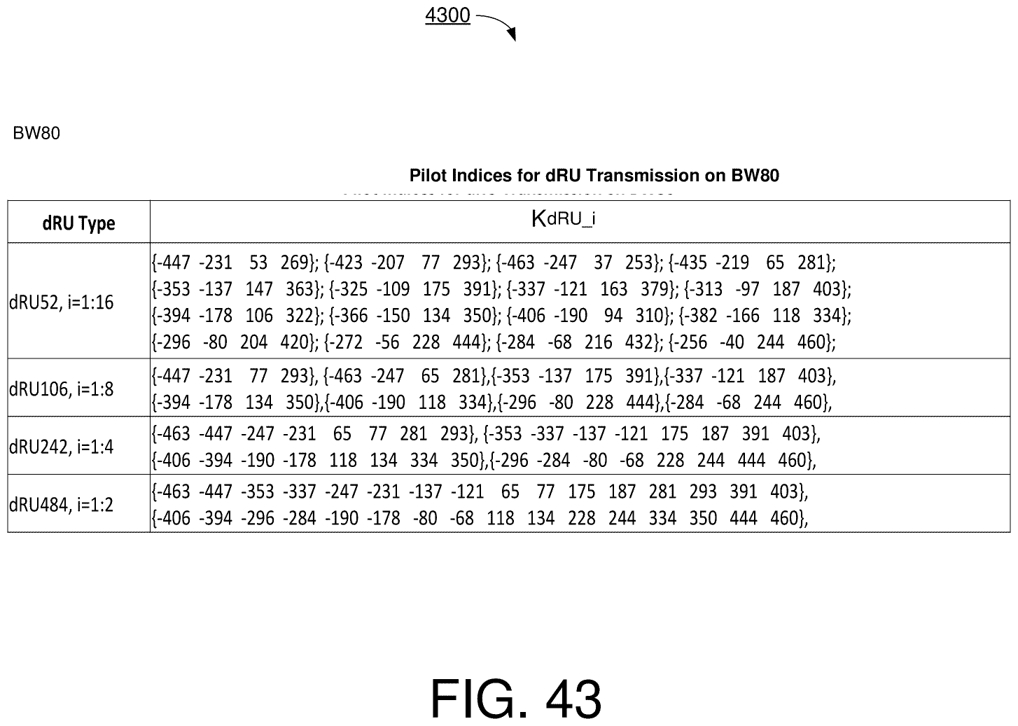

Under a proposed scheme in accordance with the present disclosure, further optimization and updates for dRU pilot tone design may be implemented. As described above, a hierarchical structure-based pilot tone design may have certain properties. For instance, the pilot tone hierarchical structure is preserved and this guarantees sufficient separation of pilot tones for any combination of dRUs. Additionally, the pilot tones of dRU26 are used as the base set for dRUs of any other size. Moreover, the hierarchical structure-based pilot tone design may achieve evenly or near-evenly distributed pilot tones over an entire BW. Furthermore, hierarchical structure-based pilot tone design may guarantee that a minimum separation between pilot tones is comparable to that for rRU or better than rRU. Under the proposed scheme, the pilot tone assignments may be updated or further optimized by using the pilot tone designs shown in FIG. 35˜FIG. 43.

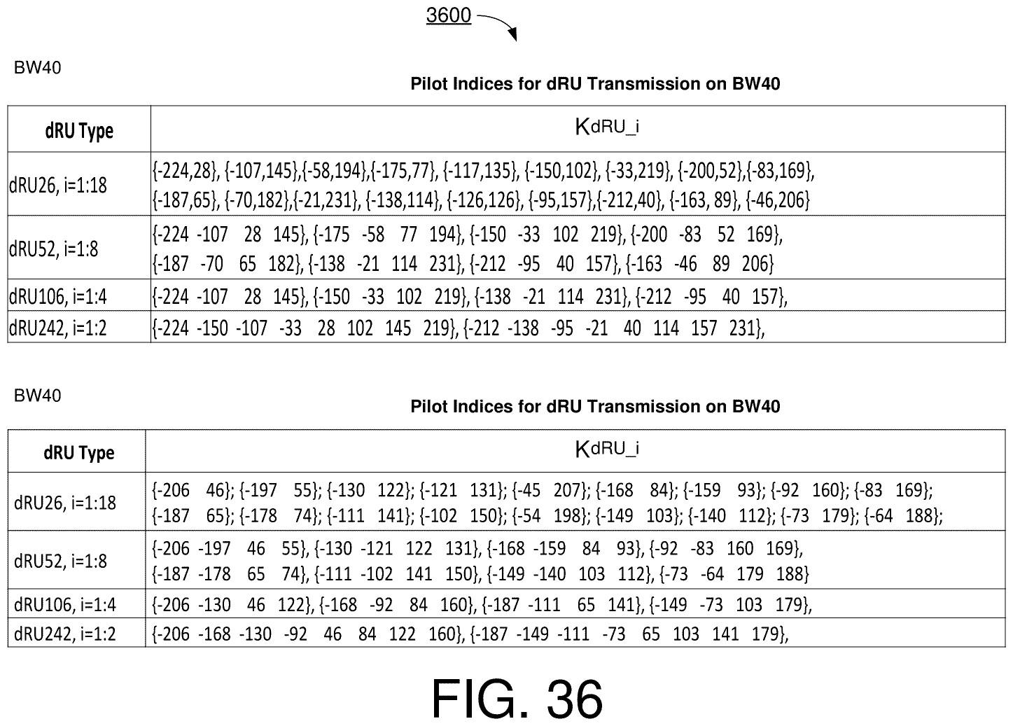

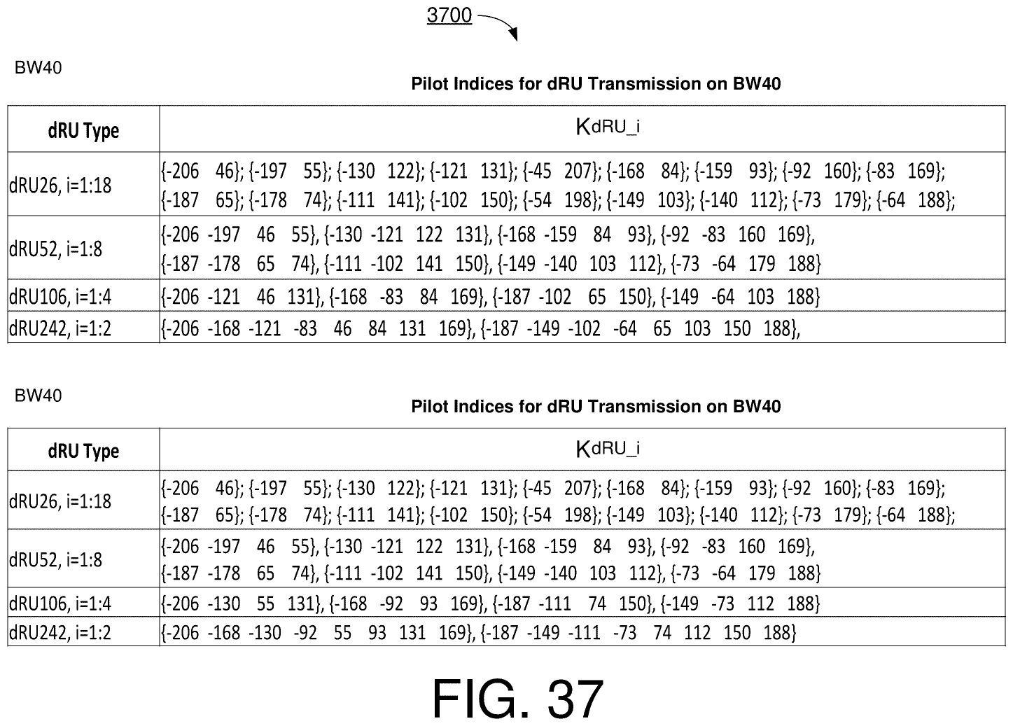

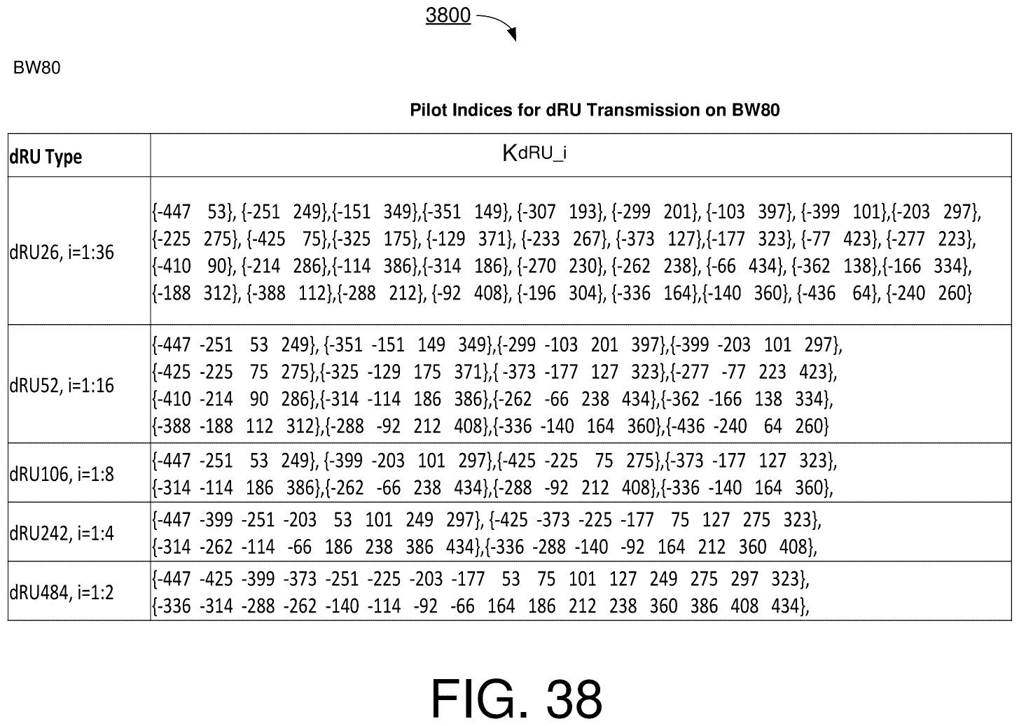

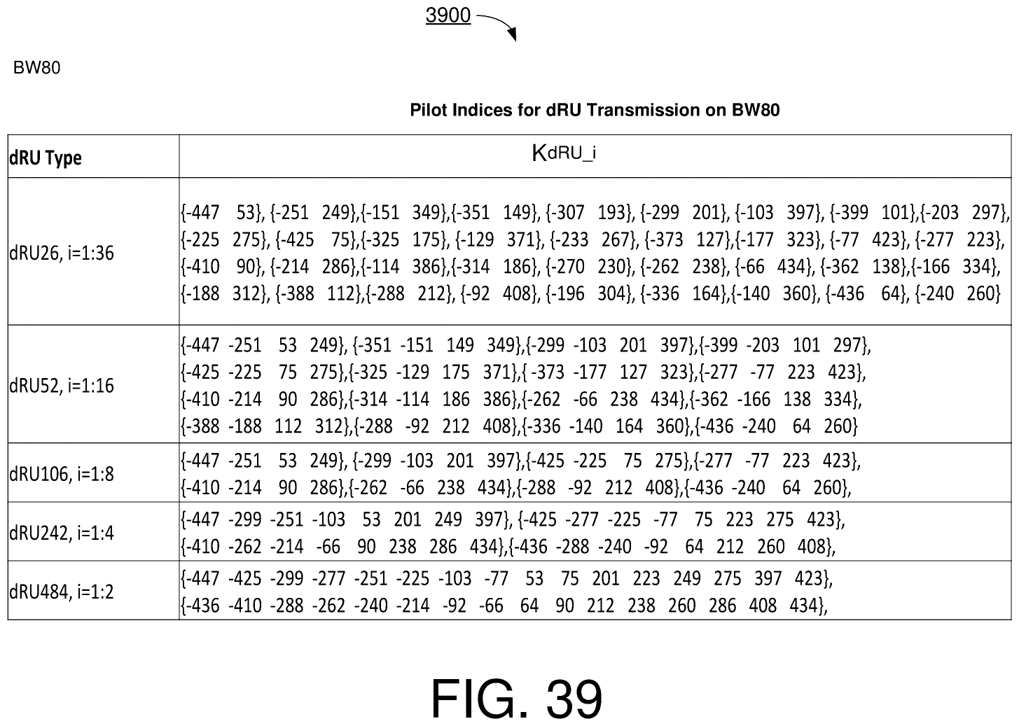

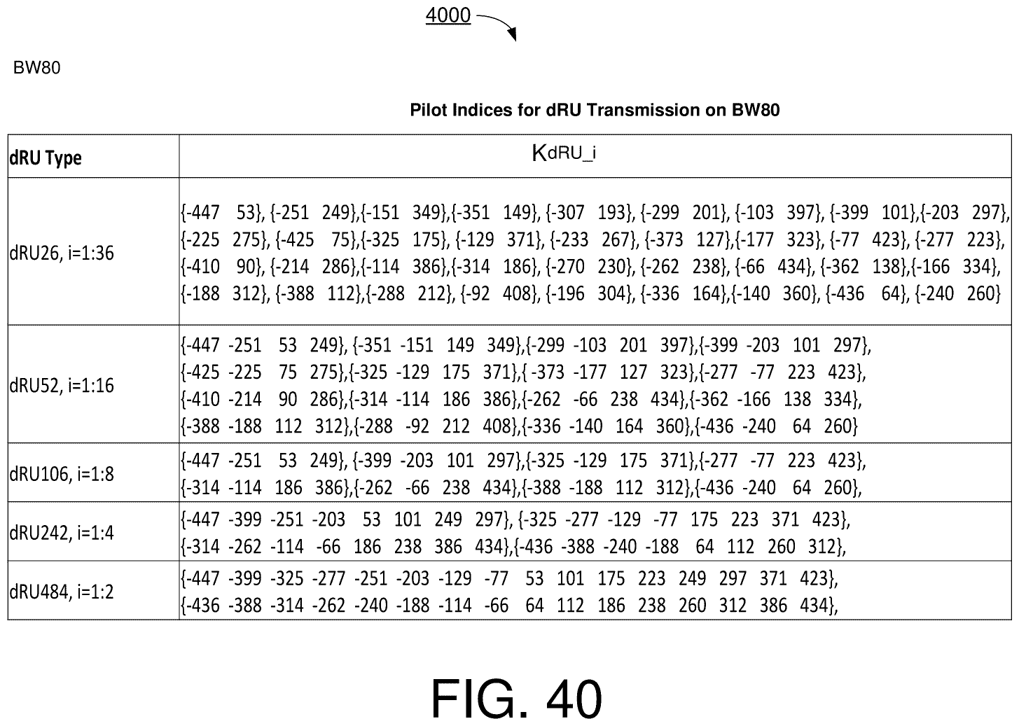

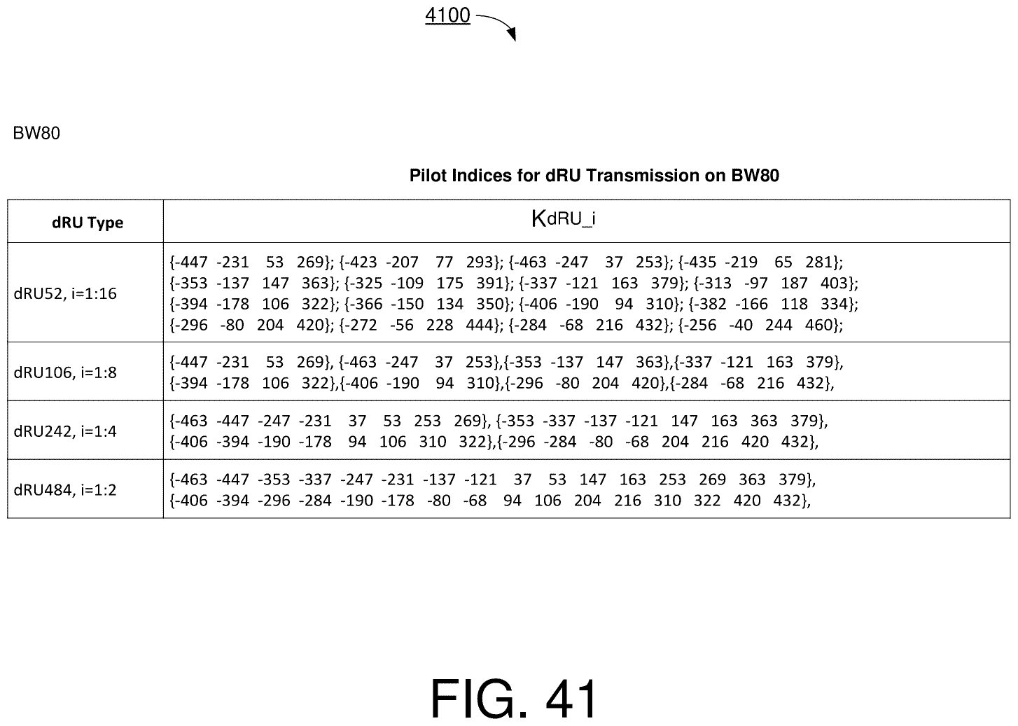

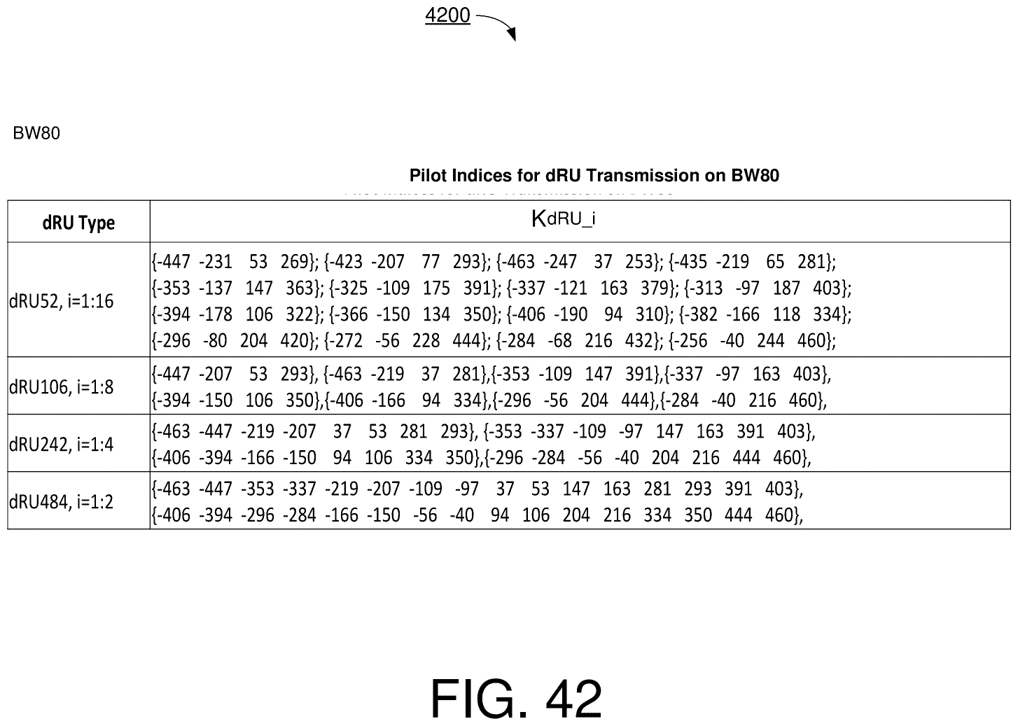

FIG. 35 illustrates an example design 3500 of further optimized pilot tone design for dRU26, dRU52 and dRU106 on BW20 under a first approach and a second approach of Option 2. FIG. 36 illustrates an example design 3600 of further optimized pilot tone design for dRU26, dRU52, dRU106 and dRU242 on BW40 under a first approach and a second approach of Option 2. FIG. 37 illustrates an example design 3700 of further optimized pilot tone design for dRU26, dRU52, dRU106 and dRU242 on BW40 under a third approach and a fourth approach of Option 2. FIG. 38 illustrates an example design 3800 of further optimized pilot tone design for dRU26, dRU52, dRU106, dRU242 and dRU484 on BW80 under a first approach of Option 2. FIG. 39 illustrates an example design 3900 of further optimized pilot tone design for dRU26, dRU52, dRU106, dRU242 and dRU484 on BW80 under a second approach of Option 2. FIG. 40 illustrates an example design 4000 of further optimized pilot tone design for dRU26, dRU52, dRU106, dRU242 and dRU484 on BW80 under a third approach of Option 2. FIG. 41 illustrates an example design 4100 of further optimized pilot tone design for dRU52, dRU106, dRU242 and dRU484 on BW80 under a fourth approach of Option 2. FIG. 42 illustrates an example design 4200 of further optimized pilot tone design for dRU52, dRU106, dRU242 and dRU484 on BW80 under a fifth approach of Option 2. FIG. 43 illustrates an example design 4300 of further optimized pilot tone design for dRU52, dRU106, dRU242 and dRU484 on BW80 under a sixth approach of Option 2.

### Illustrative Implementations

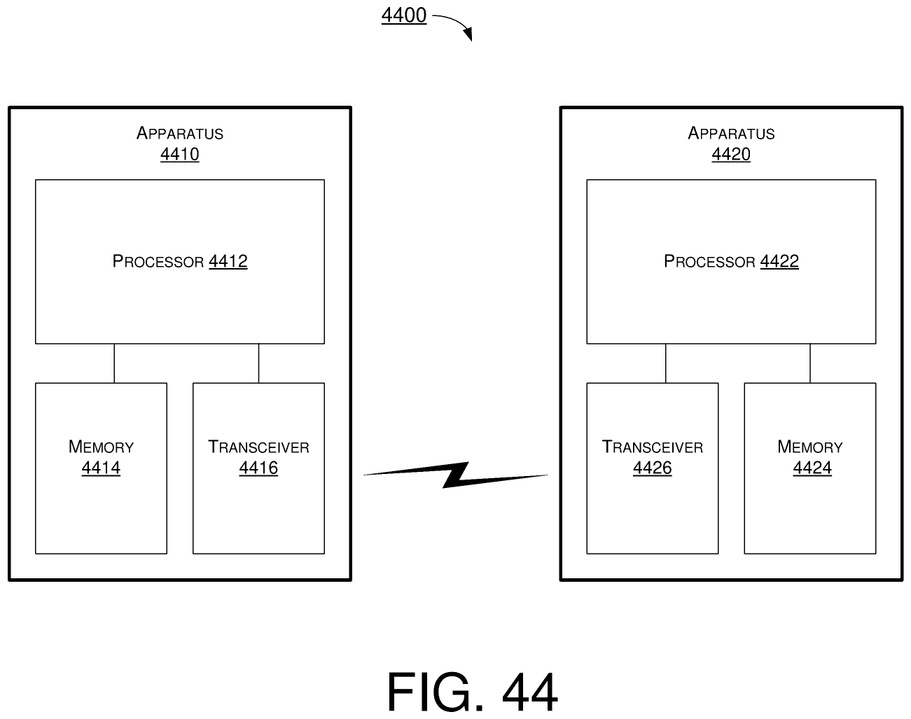

FIG. 44 illustrates an example system 4400 having at least an example apparatus 4410 and an example apparatus 4420 in accordance with an implementation of the present disclosure. Each of apparatus 4410 and apparatus 4420 may perform various functions to implement schemes, techniques, processes and methods described herein pertaining to subcarrier indices for distributed-tone RUs (dRU) in 6 GHz LPI systems, including the various schemes described above with respect to various proposed designs, concepts, schemes, systems and methods described above as well as processes described below. For instance, apparatus 4410 may be an example implementation of communication entity 110, and apparatus 4420 may be an example implementation of communication entity 120.

Each of apparatus 4410 and apparatus 4420 may be a part of an electronic apparatus, which may be a STA or an AP, such as a portable or mobile apparatus, a wearable apparatus, a wireless communication apparatus or a computing apparatus. For instance, each of apparatus 4410 and apparatus 4420 may be implemented in a smartphone, a smart watch, a personal digital assistant, a digital camera, or a computing equipment such as a tablet computer, a laptop computer or a notebook computer. Each of apparatus 4410 and apparatus 4420 may also be a part of a machine type apparatus, which may be an loT apparatus such as an immobile or a stationary apparatus, a home apparatus, a wire communication apparatus or a computing apparatus. For instance, each of apparatus 4410 and apparatus 4420 may be implemented in a smart thermostat, a smart fridge, a smart door lock, a wireless speaker or a home control center. When implemented in or as a network apparatus, apparatus 4410 and/or apparatus 4420 may be implemented in a network node, such as an AP in a WLAN.

In some implementations, each of apparatus 4410 and apparatus 4420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 4410 and apparatus 4420 may be implemented in or as a STA or an AP. Each of apparatus 4410 and apparatus 4420 may include at least some of those components shown in FIG. 44 such as a processor 4412 and a processor 4422, respectively, for example. Each of apparatus 4410 and apparatus 4420 may further include one or more other components not pertinent to the proposed scheme of the present disclosure (e.g., internal power supply, display device and/or user interface device), and, thus, such component(s) of apparatus 4410 and apparatus 4420 are neither shown in FIG. 44 nor described below in the interest of simplicity and brevity.

In one aspect, each of processor 4412 and processor 4422 may be implemented in the form of one or more single-core processors, one or more multi-core processors, one or more RISC processors or one or more CISC processors. That is, even though a singular term “a processor” is used herein to refer to processor 4412 and processor 4422, each of processor 4412 and processor 4422 may include multiple processors in some implementations and a single processor in other implementations in accordance with the present disclosure. In another aspect, each of processor 4412 and processor 4422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 4412 and processor 4422 is a special-purpose machine specifically designed, arranged and configured to perform specific tasks including those pertaining to pilot tone design for distributed-tone RUs in 6 GHz LPI systems in accordance with various implementations of the present disclosure. For instance, each of processor 4412 and processor 4422 may be configured with hardware components, or circuitry, implementing one, some or all of the examples described and illustrated herein.

In some implementations, apparatus 4410 may also include a transceiver 4416 coupled to processor 4412. Transceiver 4416 may be capable of wirelessly transmitting and receiving data. In some implementations, apparatus 4420 may also include a transceiver 4426 coupled to processor 4422. Transceiver 4426 may include a transceiver capable of wirelessly transmitting and receiving data.

In some implementations, apparatus 4410 may further include a memory 4414 coupled to processor 4412 and capable of being accessed by processor 4412 and storing data therein. In some implementations, apparatus 4420 may further include a memory 4424 coupled to processor 4422 and capable of being accessed by processor 4422 and storing data therein. Each of memory 4414 and memory 4424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 4414 and memory 4424 may include a type of read-only memory (ROM) such as mask ROM, programmable ROM (PROM), erasable programmable ROM (EPROM) and/or electrically erasable programmable ROM (EEPROM). Alternatively, or additionally, each of memory 4414 and memory 4424 may include a type of non-volatile random-access memory (NVRAM) such as flash memory, solid-state memory, ferroelectric RAM (FeRAM), magnetoresistive RAM (MRAM) and/or phase-change memory.

Each of apparatus 4410 and apparatus 4420 may be a communication entity capable of communicating with each other using various proposed schemes in accordance with the present disclosure. For illustrative purposes and without limitation, a description of capabilities of apparatus 4410, as communication entity 110, and apparatus 4420, as communication entity 120, is provided below. It is noteworthy that, although the example implementations described below are provided in the context of WLAN, the same may be implemented in other types of networks. Thus, although the following description of example implementations pertains to a scenario in which apparatus 4410 functions as a transmitting device and apparatus 4420 functions as a receiving device, the same is also applicable to another scenario in which apparatus 4410 functions as a receiving device and apparatus 4420 functions as a transmitting device.

Under a proposed scheme in accordance with the present disclosure with respect to pilot tone design for distributed-tone Rus (dRUs) in 6 GHz LPI systems, processor 4412 of apparatus 4410 may generate a plurality of pilot tones of a dRU (e.g., by distributing subcarriers of a RU) based on a hierarchical structure of pilot tones that is used for a rRU. Moreover, processor 4412 may communicate, via transceiver 4416, with apparatus 4420 using the dRU.

In some implementations, in generating the pilot tones of the dRU based on the hierarchical structure of pilot tones, processor 4412 may build a first dRU of a larger size with a first plurality of pilot tones by using a second plurality of pilot tones from two corresponding second dRUs of a smaller size.

In some implementations, in generating the pilot tones of the dRU based on the hierarchical structure of pilot tones, processor 4412 may generate a 52-tone dRU with four pilot tones of the 52-tone dRU comprising respective two pilot tones from each of two corresponding 26-tone dRUs.

In some implementations, in generating the pilot tones of the dRU based on the hierarchical structure of pilot tones, processor 4412 may generate a 106-tone dRU with four pilot tones of the 106-tone dRU comprising respective two pilot tones from each of two corresponding 52-tone dRUs.

In some implementations, in generating the pilot tones of the dRU based on the hierarchical structure of pilot tones, processor 4412 may generate a 242-tone dRU with eight pilot tones of the 242-tone dRU comprising respective four pilot tones from each of two corresponding 106-tone dRUs.

In some implementations, in generating the pilot tones of the dRU based on the hierarchical structure of pilot tones, processor 4412 may generate a 484-tone dRU with sixteen pilot tones of the 484-tone dRU comprising respective eight pilot tones from each of two corresponding 242-tone dRUs.

In some implementations, in generating the pilot tones of the dRU based on the hierarchical structure of pilot tones, processor 4412 may generate a 26-tone dRU with a separation of eleven tones between every two adjacent pilot tones in a distribution of a plurality of pilot tones of the 26-tone dRU.

In some implementations, in generating the pilot tones of the dRU based on the hierarchical structure of pilot tones, process 4500 may involve processor 4412 generating a 26-tone dRU over a 20 MHz, 40 MHz and 80 MHz bandwidth. In such cases, pilot tone indices of the 26-tone dRU over BW20 may include the following: {−111 15}, {−89 37}, {−100 26}, {−78 48}, {−67 59}, {−56 70}, {−34 92}, {−45 81}, {−23 103}. Pilot tone indices of the 26-tone dRU over BW40 may include the following: {−224 28}, {−125 127}, {−202 50}, {−103 149}, {−81 171}, {−114 138}, {−213 39}, {−92 160}, {−191 61}, {−169 83}, {−70 182}, {−147 105}, {−48 204}, {−180 72}, {−59 193}, {−158 94}, {−37 215}, {−136 116}. Pilot tone indices of the 26-tone dRU over BW80 may include the following: {−447 53}, {−359 141}, {−403 97}, {−315 185}, {−271 229}, {−227 273}, {−139 361}, {−183 317}, {−95 405}, {−117 383}, {−425 75}, {−73 427}, {−381 119}, {−161 339}, {−337 163}, {−249 251}, {−293 207}, {−205 295}, {−194 306}, {−106 394}, {−150 350}, {−62 438}, {−414 86}, {−370 130}, {−282 218}, {−326 174}, {−238 262}, {−260 240}, {−172 328}, {−216 284}, {−128 372}, {−304 196}, {−84 416}, {−392 108}, {−436 64}, {−348 152}.

In some implementations, in generating the pilot tones of the dRU based on the hierarchical structure of pilot tones, process 4500 may involve processor 4412 generating a 52-tone dRU over a 20 MHz, 40 MHz, and 80 MHz bandwidth. In such cases, pilot tone indices of the 52-tone dRU over BW20 may include the following: {−111 −89 15 37}, {−100 −78 26 48}, {−56 −34 70 92}, {−45 −23 81 103}. Pilot tone indices of the 52-tone dRU over BW40 may include the following: {−224 −125 28 127}, {−202 −103 50 149}, {−213 −114 39 138}, {−191 −92 61 160}, {−169 −70 83 182}, {−147 −48 105 204}, {−158 −59 94 193}, {−136 −37 116 215}. Pilot tone indices of the 52-tone dRU over BW80 may include the following: {−447 −359 53 141}, {−403 −315 97 185}, {−227 −139 273 361}, {−183 −95 317 405}, {−425 −117 75 383}, {−381 −73 119 427}, {−337 −249 163 251}, {−293 −205 207 295}, {−194 −106 306 394}, {−150 −62 350 438}, {−370 −282 130 218}, {−326 −238 174 262}, {−260 −172 240 328}, {−216 −128 284 372}, {−392 −84 108 416}, {−436 −348 64 152}.

In some implementations, in generating the pilot tones of the dRU based on the hierarchical structure of pilot tones, process 4500 may involve processor 4412 generating a 106-tone dRU over a 20 MHz, 40 MHz, and 80 MHz bandwidth. In such cases, pilot tone indices of the 106-tone dRU over BW20 may include the following: {−111 −78 15 48}, {−56 −23 70 103}. Pilot tone indices of the 106-tone dRU over BW40 may include the following: {−224 −125 28 127}, {−191 −92 61 160}, {−169 −70 83 182}, {−136 −37 116 215}. Pilot tone indices of the 106-tone dRU over BW80 may include the following: {−447 −359 53 141}, {−227 −139 273 361}, {−425 −117 75 383}, {−337 −249 163 251}, {−194 −106 306 394}, {−370 −282 130 218}, {−260 −172 240 328}, {−392 −84 108 416}.

In some implementations, in generating the pilot tones of the dRU based on the hierarchical structure of pilot tones, process 4500 may involve processor 4412 generating a 242-tone dRU over a 40 MHz, and 80 MHz bandwidth. In such cases, pilot tone indices of the 242-tone dRU over BW40 may include the following: {−224 −191 −125 −92 28 61 127 160}, {−169 −136 −70 −37 83 116 182 215}. Pilot tone indices of the 242-tone dRU over BW80 may include the following: {−447 −359 −227 −139 53 141 273 361}, {−425 −337 −249 −117 75 163 251 383}, {−370 −282 −194 −106 130 218 306 394}, {−392 −260 −172 −84 108 240 328 416}.

In some implementations, in generating the pilot tones of the dRU based on the hierarchical structure of pilot tones, process 4500 may involve processor 4412 generating a 484-tone dRU over a 80 MHz bandwidth. In such cases, pilot tone indices of the 484-tone dRU over BW80 may include the following: {−447 −425 −359 −337 −249 −227 −139 −117 53 75 141 163 251 273 361 383}, {−392 −370 −282 −260 −194 −172 −106 −84 108 130 218 240 306 328 394 416}.

In some implementations, a distribution of the plurality of pilot tones of the dRU may be symmetric to a DC tone along an axis of subcarrier indices.

### Illustrative Processes

FIG. 45 illustrates an example process 4500 in accordance with an implementation of the present disclosure. Process 4500 may represent an aspect of implementing various proposed designs, concepts, schemes, systems and methods described above. More specifically, process 4500 may represent an aspect of the proposed concepts and schemes pertaining to pilot tone design for distributed-tone RUs in 6 GHz LPI systems in accordance with the present disclosure. Process 4500 may include one or more operations, actions, or functions as illustrated by one or more of blocks 4510 and 4520. Although illustrated as discrete blocks, various blocks of process 4500 may be divided into additional blocks, combined into fewer blocks, or eliminated, depending on the desired implementation. Moreover, the blocks/sub-blocks of process 4500 may be executed in the order shown in FIG. 45 or, alternatively in a different order. Furthermore, one or more of the blocks/sub-blocks of process 4500 may be executed repeatedly or iteratively. Process 4500 may be implemented by or in apparatus 4410 and apparatus 4420 as well as any variations thereof. Solely for illustrative purposes and without limiting the scope, process 4500 is described below in the context of apparatus 4410 as communication entity 110 (e.g., a transmitting device whether a STA or an AP) and apparatus 4420 as communication entity 120 (e.g., a receiving device whether a STA or an AP) of a wireless network such as a WLAN in accordance with one or more of IEEE 802.11 standards. Process 4500 may begin at block 4510.

At 4510, process 4500 may involve processor 4412 of apparatus 4410 generating a plurality of pilot tones of a dRU (e.g., by distributing subcarriers of a RU) based on a hierarchical structure of pilot tones that is used for a rRU. Process 4500 may proceed from 4510 to 4520.

At 4520, process 4500 may involve processor 4412 communicating, via transceiver 4416, with apparatus 4420 using the dRU.

In some implementations, in generating the pilot tones of the dRU based on the hierarchical structure of pilot tones, process 4500 may involve processor 4412 building a first dRU of a larger size with a first plurality of pilot tones by using a second plurality of pilot tones from two corresponding second dRUs of a smaller size.

In some implementations, in generating the pilot tones of the dRU based on the hierarchical structure of pilot tones, process 4500 may involve processor 4412 generating a 52-tone dRU with four pilot tones of the 52-tone dRU comprising respective two pilot tones from each of two corresponding 26-tone dRUs.

In some implementations, in generating the pilot tones of the dRU based on the hierarchical structure of pilot tones, process 4500 may involve processor 4412 generating a 106-tone dRU with four pilot tones of the 106-tone dRU comprising respective two pilot tones from each of two corresponding 52-tone dRUs.

In some implementations, in generating the pilot tones of the dRU based on the hierarchical structure of pilot tones, process 4500 may involve processor 4412 generating a 242-tone dRU with eight pilot tones of the 242-tone dRU comprising respective four pilot tones from each of two corresponding 106-tone dRUs.

In some implementations, in generating the pilot tones of the dRU based on the hierarchical structure of pilot tones, process 4500 may involve processor 4412 generating a 484-tone dRU with sixteen pilot tones of the 484-tone dRU comprising respective eight pilot tones from each of two corresponding 242-tone dRUs.

In some implementations, in generating the pilot tones of the dRU based on the hierarchical structure of pilot tones, process 4500 may involve processor 4412 generating a 26-tone dRU with a separation of eleven tones between every two adjacent pilot tones in a distribution of a plurality of pilot tones of the 26-tone dRU.

In some implementations, in generating the pilot tones of the dRU based on the hierarchical structure of pilot tones, process 4500 may involve processor 4412 generating a 26-tone dRU over a 20 MHz, 40 MHz and 80 MHz bandwidth. In such cases, pilot tone indices of the 26-tone dRU over BW20 may include the following: {−111 15}, {−89 37}, {−100 26}, {−78 48}, {−67 59}, {−56 70}, {−34 92}, {−45 81}, {−23 103}. Pilot tone indices of the 26-tone dRU over BW40 may include the following: {−224 28}, {−125 127}, {−202 50}, {−103 149}, {−81 171}, {−114 138}, {−213 39}, {−92 160}, {−191 61}, {−169 83}, {−70 182}, {−147 105}, {−48 204}, {−180 72}, {−59 193}, {−158 94}, {−37 215}, {−136 116}. Pilot tone indices of the 26-tone dRU over BW80 may include the following: {−447 53}, {−359 141}, {−403 97}, {−315 185}, {−271 229}, {−227 273}, {−139 361}, {−183 317}, {−95 405}, {−117 383}, {−425 75}, {−73 427}, {−381 119}, {−161 339}, {−337 163}, {−249 251}, {−293 207}, {−205 295}, {−194 306}, {−106 394}, {−150 350}, {−62 438}, {−414 86}, {−370 130}, {−282 218}, {−326 174}, {−238 262}, {−260 240}, {−172 328}, {−216 284}, {−128 372}, {−304 196}, {−84 416}, {−392 108}, {−436 64}, {−348 152}.

In some implementations, in generating the pilot tones of the dRU based on the hierarchical structure of pilot tones, process 4500 may involve processor 4412 generating a 52-tone dRU over a 20 MHz, 40 MHz, and 80 MHz bandwidth. In such cases, pilot tone indices of the 52-tone dRU over BW20 may include the following: {−111 −89 15 37}, {−100 −78 26 48}, {−56 −34 70 92}, {−45 −23 81 103}. Pilot tone indices of the 52-tone dRU over BW40 may include the following: {−224 −125 28 127}, {−202 −103 50 149}, {−213 −114 39 138}, {−191 −92 61 160}, {−169 −70 83 182}, {−147 −48 105 204}, {−158 −59 94 193}, {−136 −37 116 215}. Pilot tone indices of the 52-tone dRU over BW80 may include the following: {−447 −359 53 141}, {−403 −315 97 185}, {−227 −139 273 361}, {−183 −95 317 405}, {−425 −117 75 383}, {−381 −73 119 427}, {−337 −249 163 251}, {−293 −205 207 295}, {−194 −106 306 394}, {−150 −62 350 438}, {−370 −282 130 218}, {−326 −238 174 262}, {−260 −172 240 328}, {−216 −128 284 372}, {−392 −84 108 416}, {−436 −348 64 152}.

In some implementations, in generating the pilot tones of the dRU based on the hierarchical structure of pilot tones, process 4500 may involve processor 4412 generating a 106-tone dRU over a 20 MHz, 40 MHz, and 80 MHz bandwidth. In such cases, pilot tone indices of the 106-tone dRU over BW20 may include the following: {−111 −78 15 48}, {−56 −23 70 103}. Pilot tone indices of the 106-tone dRU over BW40 may include the following: {−224 −125 28 127}, {−191 −92 61 160}, {−169 −70 83 182}, {−136 −37 116 215}. Pilot tone indices of the 106-tone dRU over BW80 may include the following: {−447 −359 53 141}, {−227 −139 273 361}, {−425 −117 75 383}, {−337 −249 163 251}, {−194 −106 306 394}, {−370 −282 130 218}, {−260 −172 240 328}, {−392 −84 108 416}.

In some implementations, in generating the pilot tones of the dRU based on the hierarchical structure of pilot tones, process 4500 may involve processor 4412 generating a 242-tone dRU over a 40 MHz, and 80 MHz bandwidth. In such cases, pilot tone indices of the 242-tone dRU over BW40 may include the following: {−224 −191 −125 −92 28 61 127 160}, {−169 −136 −70 −37 83 116 182 215}. Pilot tone indices of the 242-tone dRU over BW80 may include the following: {−447 −359 −227 −139 53 141 273 361}, {−425 −337 −249 −117 75 163 251 383}, {−370 −282 −194 −106 130 218 306 394}, {−392 −260 −172 −84 108 240 328 416}.

In some implementations, in generating the pilot tones of the dRU by distributing the subcarriers of the RU based on the hierarchical structure of pilot tones, process 4500 may involve processor 4412 generating a 484-tone dRU over a 80 MHz bandwidth. In such cases, pilot tone indices of the 484-tone dRU over BW80 may include the following: {−447 −425 −359 −337 −249 −227 −139 −117 53 75 141 163 251 273 361 383}, {−392 −370 −282 −260 −194 −172 −106 −84 108 130 218 240 306 328 394 416}.

In some implementations, a distribution of the plurality of pilot tones of the dRU may be symmetric to a DC tone along an axis of subcarrier indices.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating a plurality of pilot tones of a distributed-tone resource unit (dRU) based on a hierarchical structure of pilot tones that is used for a regular RU (rRU); and
communicating using the dRU,
wherein the generating of the pilot tones of the dRU based on the hierarchical structure of pilot tones comprises generating a 26-tone dRU and any of a 52-tone dRU or a 106-tone dRU over a 20 MHz bandwidth, a 40 MHz bandwidth and an 80 MHz bandwidth,
wherein pilot tone indices of the 26-tone dRU over the 40 MHz bandwidth comprise {−224 28}, {−125 127}, {−202 50}, {−103 149}, {−81 171}, {−114 138}, {−213 39}, {−92 160}, {−191 61}, {−169 83}, {−70 182}, {−147 105}, {−48 204}, {−180 72}, {−59 193}, {−158 94}, {−37 215}, {−136 116},
wherein pilot tone indices of the 52-tone dRU over the 20 MHz bandwidth comprise {−111 −89 15 37}, {−100 −78 26 48}, {−56 −34 70 92}, {−45 −23 81 103}, wherein pilot tone indices of the 52-tone dRU over the 40 MHz bandwidth comprise {−224 −125 28 127}, {−202 −103 50 149}, {−213 −114 39 138}, {−191 −92 61 160}, {−169 −70 83 182}, {−147 −48 105 204}, {−158 −59 94 193}, {−136 −37 116 215}, and wherein pilot tone indices of the 52-tone dRU over the 80 MHz bandwidth comprise {−447 −359 53 141}, {−403 −315 97 185}, {−227 −139 273 361}, {−183 −95 317 405}, {−425 −117 75 383}, {−381 −73 119 427}, {−337 −249 163 251}, {−293 −205 207 295}, {−194 −106 306 394}, {−150 −62 350 438}, {−370 −282 130 218}, {−326 −238 174 262}, {−260 −172 240 328}, {−216 −128 284 372}, {−392 −84 108 416}, {−436 −348 64 152},
wherein pilot tone indices of the 106-tone dRU over the 20 MHz bandwidth comprise {−111 −78 15 48}, {−56 −23 70 103},
wherein pilot values of dRUs having two pilot tones comprise [1 −1],
wherein pilot values of dRUs having four pilot tones comprise [1 1 1 −1], and
wherein pilot values of dRUs having eight pilot tones comprise [1 1 1 −1 −1 1 1 1].

2. The method of claim 1, wherein the generating of the pilot tones of the dRU based on the hierarchical structure of pilot tones comprises building a first dRU of a larger size with a first plurality of pilot tones by using a second plurality of pilot tones from two corresponding second dRUs of a smaller size.

3. The method of claim 1, wherein the generating of the pilot tones of the dRU based on the hierarchical structure of pilot tones comprises generating a 52-tone dRU with four pilot tones of the 52-tone dRU comprising respective two pilot tones from each of two corresponding 26-tone dRUs.

4. The method of claim 1, wherein the generating of the pilot tones of the dRU based on the hierarchical structure of pilot tones comprises generating a 106-tone dRU with four pilot tones of the 106-tone dRU comprising respective two pilot tones from each of two corresponding 52-tone dRUs.

5. The method of claim 1, wherein the generating of the pilot tones of the dRU based on the hierarchical structure of pilot tones comprises generating a 242-tone dRU with eight pilot tones of the 242-tone dRU comprising respective four pilot tones from each of two corresponding 106-tone dRUs.

6. The method of claim 1, wherein the generating of the pilot tones of the dRU based on the hierarchical structure of pilot tones comprises generating a 484-tone dRU with sixteen pilot tones of the 484-tone dRU comprising respective eight pilot tones from each of two corresponding 242-tone dRUs.

7. The method of claim 1, wherein pilot tone indices of the 26-tone dRU over the 80 MHz bandwidth comprise {−447 53}, {−359 141}, {−403 97}, {−315 185}, {−271 229}, {−227 273}, {−139 361}, {−183 317}, {−95 405}, {−117 383}, {−425 75}, {−73 427}, {−381 119}, {−161 339}, {−337 163}, {−249 251}, {−293 207}, {−205 295}, {−194 306}, {−106 394}, {−150 350}, {−62 438}, {−414 86}, {−370 130}, {−282 218}, {−326 174}, {−238 262}, {−260 240}, {−172 328}, {−216 284}, {−128 372}, {−304 196}, {−84 416}, {−392 108}, {−436 64}, {−348 152}.

8. The method of claim 1, wherein pilot tone indices of the 106-tone dRU over the 40 MHz bandwidth comprise {−224 −125 28 127}, {−191 −92 61 160}, {−169 −70 83 182}, {−136 −37 116 215}.

9. The method of claim 1, wherein pilot tone indices of the 106-tone dRU over the 80 MHz bandwidth comprise {−447 −359 53 141}, {−227 −139 273 361}, {−425 −117 75 383}, {−337 −249 163 251}, {−194 −106 306 394}, {−370 −282 130 218}, {−260 −172 240 328}, {−392 −84 108 416}.

10. The method of claim 1, wherein pilot tone indices of the 26-tone dRU over the 20 MHz bandwidth comprise {−111 15}, {−89 37}, {−100 26}, {−78 48}, {−67 59}, {−56 70}, {−34 92}, {−45 81}, {−23 103}.

11. The method of claim 1, wherein a distribution of the pilot tones of the dRU is symmetric to a direct-current (DC) tone along an axis of subcarrier indices.

12. An apparatus, comprising:
a transceiver configured to transmit and receive wirelessly; and
a processor coupled to the transceiver and configured to perform operations comprising:
generating a plurality of pilot tones of a distributed-tone resource unit (dRU) based on a hierarchical structure of pilot tones that is used for a regular RU (rRU); and
communicating, via the transceiver, using the dRU,
wherein, in generating the pilot tones of the dRU based on the hierarchical structure of pilot tones, the processor is configured to generate a 26-tone dRU and any of a 52-tone dRU or a 106-tone dRU over a 20 MHz bandwidth, a 40 MHz bandwidth and an 80 MHz bandwidth,
wherein pilot tone indices of the 26-tone dRU over the 40 MHz bandwidth comprise {−224 28}, {−125 127}, {−202 50}, {−103 149}, {−81 171}, {−114 138}, {−213 39}, {−92 160}, {−191 61}, {−169 83}, {−70 182}, {−147 105}, {−48 204}, {−180 72}, {−59 193}, {−158 94}, {−37 215}, {−136 116},
wherein pilot tone indices of the 52-tone dRU over the 20 MHz bandwidth comprise {−111 −89 15 37}, {−100 −78 26 48}, {−56 −34 70 92}, {−45 −23 81 103}, wherein pilot tone indices of the 52-tone dRU over the 40 MHz bandwidth comprise {−224 −125 28 127}, {−202 −103 50 149}, {−213 −114 39 138}, {−191 −92 61 160}, {−169 −70 83 182}, {−147 −48 105 204}, {−158 −59 94 193}, {−136 −37 116 215}, and wherein pilot tone indices of the 52-tone dRU over the 80 MHz bandwidth comprise {−447 −359 53 141}, {−403 −315 97 185}, {−227 −139 273 361}, {−183 −95 317 405}, {−425 −117 75 383}, {−381 −73 119 427}, {−337 −249 163 251}, {−293 −205 207 295}, {−194 −106 306 394}, {−150 −62 350 438}, {−370 −282 130 218}, {−326 −238 174 262}, {−260 −172 240 328}, {−216 −128 284 372}, {−392 −84 108 416}, {−436 −348 64 152},
wherein pilot tone indices of the 106-tone dRU over the 20 MHz bandwidth comprise {−111 −78 15 48}, {−56 −23 70 103},
wherein pilot values of dRUs having two pilot tones comprise [1 −1],
wherein pilot values of dRUs having four pilot tones comprise [1 1 1 −1], and
wherein pilot values of dRUs having eight pilot tones comprise [1 1 1 −1 −1 1 1 1].

13. The apparatus of claim 12, wherein, in generating the pilot tones of the dRU based on the hierarchical structure of pilot tones, the processor is configured to generate a 52-tone dRU with four pilot tones of the 52-tone dRU comprising respective two pilot tones from each of two corresponding 26-tone dRUs.

14. The apparatus of claim 12, wherein, in generating the pilot tones of the dRU based on the hierarchical structure of pilot tones, the processor is configured to generate a 106-tone dRU with four pilot tones of the 106-tone dRU comprising respective two pilot tones from each of two corresponding 52-tone dRUs.

15. The apparatus of claim 12, wherein, in generating the pilot tones of the dRU based on the hierarchical structure of pilot tones, the processor is configured to generate a 242-tone dRU with eight pilot tones of the 242-tone dRU comprising respective four pilot tones from each of two corresponding 106-tone dRUs.

16. The apparatus of claim 12, wherein, in generating the pilot tones of the dRU based on the hierarchical structure of pilot tones, the processor is configured to generate a 484-tone dRU with sixteen pilot tones of the 484-tone dRU comprising respective eight pilot tones from each of two corresponding 242-tone dRUs.

17. The apparatus of claim 12, wherein pilot tone indices of the 26-tone dRU over the 80 MHz bandwidth comprise {−447 53}, {−359 141}, {−403 97}, {−315 185}, {−271 229}, {−227 273}, {−139 361}, {−183 317}, {−95 405}, {−117 383}, {−425 75}, {−73 427}, {−381 119}, {−161 339}, {−337 163}, {−249 251}, {−293 207}, {−205 295}, {−194 306}, {-106 394}, {−150 350}, {−62 438}, {−414 86}, {−370 130}, {−282 218}, {−326 174}, {−238 262}, {−260 240}, {−172 328}, {−216 284}, {−128 372}, {−304 196}, {−84 416}, {−392 108}, {−436 64}, {−348 152}.

18. The apparatus of claim 12, wherein pilot tone indices of the 106-tone dRU over the 40 MHz bandwidth comprise {−224 −125 28 127}, {−191 −92 61 160}, {−169 −70 83 182}, {−136 −37 116 215}.

19. The apparatus of claim 12, wherein pilot tone indices of the 106-tone dRU over the 80 MHz bandwidth comprise {−447 −359 53 141}, {−227 −139 273 361}, {−425 −117 75 383}, {−337 −249 163 251}, {−194 −106 306 394}, {−370 −282 130 218}, {−260 −172 240 328}, {−392 −84 108 416}.

20. The apparatus of claim 12, wherein pilot tone indices of the 26-tone dRU over the 20 MHz bandwidth comprise {−111 15}, {−89 37}, {−100 26}, {−78 48}, {−67 59}, {−56 70}, {−34 92}, {−45 81}, {−23 103}.
